(19) United States
(12) Patent Application Publication
(10) Pub. No.: US 2023/0021621 A1
(43) Pub. Date: Jan. 26, 2023

(54) SYSTEMS AND METHODS FOR TRAINING ENERGY-EFFICIENT SPIKING GROWTH TRANSFORM NEURAL NETWORKS

(71) Applicant: Washington University, St. Louis, MO (US)

(72) Inventors: Shantanu Chakrabartty, St. Louis, MO (US); Ahana Gangopadhyay, St. Louis, MO (US)

(21) Appl. No.: 17/809,713

(22) Filed: Jun. 29, 2022

Related U.S. Application Data
(60) Provisional application No. 63/216,242, filed on Jun. 29, 2021.

(51) Int. Cl. G06N 3/08

(52) U.S. Cl. CPC G06N 3/08

(57) ABSTRACT

Growth-transform (GT) neurons and their population models allow for independent control over spiking statistics and transient population dynamics while optimizing a physically plausible distributed energy functional involving continuous-valued neural variables. A backpropagation-less learning approach trains a GT network of spiking GT neurons by enforcing sparsity constraints on network spiking activity overall. Spike responses are generated because of constraint violations. Optimal parameters for a given task is learned using neurally relevant local learning rules and in an online manner. The GT network optimizes itself to encode the solution with as few spikes as possible and operate at a solution with the maximum dynamic range and away from saturation. Further, the framework is flexible enough to incorporate additional structural and connectivity constraints on the GT network. The framework formulation is used to design neuromorphic tinyML systems that are constrained in energy, resources, and network structure.

### CROSS-REFERENCE TO RELATED APPLICATIONS

This application claims the benefit of U.S. Provisional 63/216,242, filed Jun. 29, 2021, which is hereby incorporated by reference in its entirety.

### STATEMENT REGARDING FEDERALLY SPONSORED RESEARCH & DEVELOPMENT

This invention was made with government support under ECCS1935073 awarded by the National Science Foundation. The government has certain rights in this invention.

### FIELD OF THE DISCLOSURE

The present disclosure relates to systems and methods for designing neuromorphic systems and, more particularly, designing neuromorphic systems that are constrained in energy, resources, and network structure.

### BACKGROUND

Deployment of miniaturized and battery-powered sensors and devices has become ubiquitous and computation is increasingly moving from the cloud to the source of data collection. With it, there is a growing demand for specialized algorithms, hardware and software, collectively termed as tinyML systems. TinyML systems typically can perform learning and inference at the edge in energy and resource-constrained environments. Prior efforts at reducing energy requirements of classic machine learning algorithms include network architecture search, model compression through energy-aware pruning and quantization, model partitioning, among others.

Neuromorphic systems naturally lend themselves to resource-efficient computation, deriving inspiration from tiny brains, such as insect brains, that not only occupy a small form-factor but also exhibit high energy-efficiency. Some neuromorphic algorithms using event-driven communication on specialized hardware have been claimed to outperform their classic counterparts running on traditional hardware in energy costs by orders of magnitude in benchmarking tests across applications. However, like traditional Machine Learning (ML) approaches, advantages in energy-efficiency where only demonstrated during inference. The implementation of spike-based learning and training has proven to be a challenge.

For a vast majority of energy-based learning models, backpropagation remains the tool of choice for training spiking neural networks. In order to resolve differences due to continuous-valued neural outputs in traditional neural networks and discrete outputs generated by spiking neurons in their neuromorphic counterparts, transfer techniques that map deep neural nets to their spiking counterparts through rate-based conversions are widely used. Other approaches formulate loss functions that penalize the difference between actual and desired spike-times, or approximate derivatives of spike signals through various means to calculate error gradients for backpropagation.

Further, there are neuromorphic algorithms that use local learning rules, such as the Synaptic Time-Dependent Plasticity (STDP) for learning lower-level feature representations in spiking neural networks. Some of these are unsupervised algorithms that combine the learned features with an additional layer of supervision using separate classifiers or spike counts. Other techniques adapt weights in specific directions to reproduce desired output patterns or templates in the decision layer. For example, a spike, or high firing rate, in response to a positive pattern and silence, or low firing rate, otherwise. Examples include supervised synaptic learning rules, such as the tempotron implementing temporal credit assignments according to elicited output responses and algorithms using teaching signals to drive outputs in the decision layer.

From the perspective of tinyML systems, each of the above described approaches have their own shortcomings. For example, backpropagation has long been criticized due to issues arising from weight transport and update locking, both of which, aside from their biological implausibility, pose serious limitations for resource constrained computing platforms. Weight transport problem refers to the perfect symmetry requirement between feed-forward and feedback weights in backpropagation, making weight updates non-local and requiring each layer to have complete information about all weights from downstream layers. This reliance on global information leads to significant energy and latency overheads in hardware implementations. Update locking implies that backpropagation has to wait for a full forward pass before weight updates can occur in the backward pass, causing high memory overhead due to the necessity of buffering inputs and activations corresponding to all layers. On the other hand, neuromorphic algorithms relying on local learning rules do not require global information and buffering of intermediate values for performing weight updates. However, these algorithms are not optimized with respect to a network objective, and it is difficult to interpret their dynamics and fully optimize the network parameters for solving a certain task. Additionally, neither of these existing approaches inherently incorporates optimization for sparsity within a learning framework. Similar to biological systems, with respect to tinyML systems, the generation and transmission of spike information from one part of a network to the other consumes the maximum amount of power in neuromorphic systems. In absence of a direct control over sparsity, energy-efficiency in neuromorphic machine learning has largely been a secondary consideration, achieved through external constraints on network connectivity and/or quantization level of its neurons and synapses, or through additional penalty terms that regularize some statistical measure of spiking activity like firing rates or the total number of synaptic operations. As shown in FIG. 4A, finding optimal weight parameters for a given task is equivalent to finding a solution that minimizes both energy functions, with relative importance being determined by a regularization hyper-parameter.

Some prior art solutions have developed algorithms for training neural networks that overcome one or more constraints of the backpropagation algorithm. One known method, feedback alignment or random backpropagation, eradicates the weight transport problem by using fixed random weights in the feedback path for propagating error gradient information. Research showed that directly propagating the output error or the raw one-hot encoded targets is sufficient to maintain feedback alignment, and, in the case of the latter, also eradicates update locking by allowing simultaneous and independent weight updates at each layer. Another biologically relevant algorithm for training energy-based models, equilibrium propagation, relaxes a network to a fixed-point of its energy function in response to an external input. In the subsequent phase when the corresponding target is revealed, the output unites are nudged towards the target in an attempt to reduce prediction error, and the resulting perturbations rippling backward through the hidden layers were shown to contain error gradient information akin to backpropagation.

Another class of known algorithms are predictive coding frameworks which use local learning rules to hierarchically minimize prediction errors. It is not clear how the above systems can be designed within a neuromorphic tinyML framework which can generate spiking responses within an energy-based model, learn optimal parameters for a given task using local learning rules, and optimize itself for sparsity such that it is able to encode the solution with the fewest number of spikes possible without relying on additional regularizing terms.

Prior art solutions, including those described above, lack the ability to design neuromorphic tinyML systems that are backpropagationless that are also able to enforce sparsity in network spiking activity in addition to conforming to additional structural or connectivity restraints imposed on the network.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF SUMMARY

The present embodiments may relate to systems and methods for designing neuromorphic systems that are constrained in energy, resources, and network structure. In one aspect, a learning framework using populations of spiking growth transform neurons is provided. In some exemplary embodiments, the system includes a computer system including at least one processor in communication with a memory.

The present embodiments may also relate to systems and methods for designing neuromorphic tinyML systems that are constrained in energy, resources, and network structure using a learning framework. Design may include the utilization of an algorithm based on the learning framework developed using resource-efficient learning methods. Learning methods may include the use of a publicly available dataset, such as a machine olfaction dataset, for example. In some embodiments, a designed system or network, is able to minimize network-level spiking activity while producing classification accuracy that are comparable to standard approaches on the same dataset.

Even further, present embodiments may relate to systems and methods for applying neuromorphic principles for tinyML architectures. For example, systems and methods for designing energy-based learning models that are also neurally relevant or backpropagation-less and at the same time enforce sparsity in the network's spiking activity.

In one aspect, a backpropagation-less learning (BPL) computing device includes at least one processor in communication with a memory device. The at least one processor is configured to: retrieve, from the memory device, at least one or more training datasets; build a spike-response model relating one or more aspects of the at least one or more training datasets; store the spike-response model in the memory device; and design, using the spike-response model, a Growth Transform (GT) neural network trained to enforce sparsity constraints on overall network spiking activity. The BPL computing device may include additional, less, or alternate functionality, including that discussed elsewhere herein.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates an exemplary Growth Transform (GT) computing system in accordance with an exemplary embodiment of the present disclosure.

FIG. 2 illustrates an exemplary client computing device that may be used with the exemplary GT computing system illustrated in FIG. 1.

FIG. 3 illustrates an exemplary server computing device that may be used with the exemplary GT computing system illustrated in FIG. 1.

FIGS. 4A and 4B illustrate energy efficiency in energy-based neuromorphic machine learning and sparsity-driven energy-based neuromorphic machine learning.

FIGS. 5A-D illustrate spike generation viewed as a constraint violation in accordance with at least one embodiment.

FIGS. 6A-6E illustrate an on-off GT neuron model for stimulus encoding in accordance with at least one embodiment.

FIGS. 7A-7H illustrate sparsity-driven weight adaptation using a differential network with two neuron pairs presented with a constant external input vector.

FIGS. 8A-8H illustrate an exemplary domain description problem in accordance with at least one embodiment.

FIGS. 9A-9C illustrate exemplary anomaly detection in accordance with at least one embodiment.

FIGS. 10A-10F illustrate an exemplary linear classification framework with a feed-forward architecture in accordance with at least one embodiment.

FIGS. 11A-11C illustrate exemplary classification based on random projections in accordance with at least one embodiment.

FIGS. 12A-12E illustrate exemplary classification based on layer-wise training in accordance with at least one embodiment.

FIGS. 13A-13C illustrate exemplary classification including target information in layer-wise training of fully-connected layers in accordance with at least one embodiment.

FIGS. 14A-14C illustrate exemplary plots of training accuracy and sparsity metrics in accordance with at least one embodiment.

FIGS. 15A and 15B illustrate exemplary metrics for GTNN architectures in accordance with at least one embodiment.

FIGS. 16A-16C illustrate exemplary classification performance of GTNN architectures in accordance with at least one embodiment.

FIGS. 17A-17F illustrate exemplary population activity in a GT network with synaptic adaptation in accordance with at least one embodiment.

FIG. 18 illustrates exemplary elements of neuromorphic hardware in accordance with at least one embodiment of the prior art.

FIG. 19 illustrates an exemplary diagram of a GTNN architecture in accordance with at least one embodiment.

FIGS. 20A and 20B illustrate exemplary circuitry diagrams of GT neurons in accordance with at least one embodiment.

FIG. 21 illustrates exemplary time-scale plots of a GTNN architecture in accordance with at least one embodiment.

FIGS. 22A-22C illustrate exemplary performance plot diagrams of a GTNN architecture in accordance with at least one embodiment.

FIGS. 23-25 illustrate exemplary process diagrams 2300, 2400 and 2500 in accordance with one or more embodiments.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for designing neuromorphic systems and, more particularly, designing neuromorphic tinyML systems that are constrained in energy, resources, and network structure. In one exemplary embodiment, the process may be performed by one or more computing devices, such as a Growth-Transform (GT) computing device.

The disclosure may reference notations as shown below in Table 1. The notations listed are in no way meant to be exhaustive or limiting.

TABLE 1
Notations

| | |
|---|---|
| x | Real scalar variable |
| x | Real-valued vector with xᵢ as its i-th element |
| X | Real-valued matrix with Xᵢⱼ as the element at |
| | the i-th row and the j-th column |
| xᵢ (t) | i-th element of real-valued vector x at time t |
| x̅ (t) | Empirical expectation of the time-varying signal x (t) estimated |
| | over an asymptotically infinite window, |
| | $i . e . , {lim}_{T \to ∞} \frac{1}{T} {\int }_{0}^{T} x ( t ) dt$ |
| [symbol] ^{M} | Vector space spanned by M-dimensional real vectors |
| \|x\| | Absolute value of a scalar |
| ∥x∥ₚ | ${l}_{p} ‐ norm of an M ‐ dimensional vector , define as {( {\sum }_{i = 1}^{M} {\vert {x}_{i} \vert}^{p} )}^{1 / p}$ |
| x^{T} | Transpose of the vector x |
| $\frac{\partial ℋ}{\partial x}$ | $Gradient {vector [ \frac{\partial ℋ}{\partial {x}_{1}} , \frac{\partial ℋ}{\partial {x}_{2}} , … , \frac{\partial ℋ}{\partial {x}_{M}} ]}^{T}$ |

The disclosure may refer to information as shown in Table 2. The information may include batch-wise information, final test accuracies and sparsity metrics evaluated on test data for a UCSD gas sensor drift dataset with Networks (N/w) 1-3 and with a Multi-layer Perceptron (MLP) network.

TABLE 2
Batch-wise information, final test accuracies and sparsity metrics evaluated on test data for
the UCSD gas sensor drift dataset with Networks 1-3 and with a Multi-layer Perceptron network.

| Batch | | 1 | 2 | 3 | 4 | 5 | 6 | 7 | 8 | 9 | 10 |
|---|---|---|---|---|---|---|---|---|---|---|---|
| Data points | | 445 | 1244 | 1586 | 161 | 197 | 2300 | 3613 | 294 | 470 | 3600 |
| N/w 1 | Acc. (%) | 94.39 | 95.20 | 95.85 | 100.00 | 98.41 | 89.39 | 83.16 | 84.73 | 97.22 | 72.36 |
| | Sₜₑₛₜ | 0.0910 | 0.1113 | 0.0910 | 0.0972 | 0.0877 | 0.0914 | 0.0942 | 0.1061 | 0.0925 | 0.0703 |
| N/w 2 | Acc. (%) | 92.33 | 97.55 | 97.53 | 98.91 | 98.41 | 96.56 | 90.90 | 88.17 | 96.11 | 80.59 |
| | Sₜₑₛₜ | 0.0819 | 0.0923 | 0.0891 | 0.0885 | 0.0852 | 0.0800 | 0.0886 | 0.0868 | 0.0821 | 0.0760 |
| N/w 3 | Acc. (%) | 93.80 | 95.58 | 92.81 | 92.39 | 100.00 | 98.85 | 88.56 | 87.19 | 98.06 | 66.54 |
| | Sₜₑₛₜ | 0.0260 | 0.0290 | 0.0316 | 0.0290 | 0.0254 | 0.0270 | 0.0355 | 0.0542 | 0.0302 | 0.0398 |
| MLP | Acc. (%) | 95.63 | 95.42 | 94.53 | 99.56 | 99.20 | 90.27 | 89.96 | 86.50 | 98.11 | 80.81 |

The present embodiments may include, inter alia, systems and methods for providing a backpropagation-less learning approach to train a network of spiking GT neurons by enforcing sparsity constraints on overall network spiking activity. Features of the learning framework may include, but is not limited to: (i) spike responses are generated as a result of constraint violation and hence can be viewed as Lagrangian parameters; (b) the optimal parameters for a given task can be learned using neurally relevant local learning rules and in an online manner; (c) the network optimizes itself to encode the solution with as few spikes as possible (sparsity); (d) the network optimizes itself to operate at a solution with the maximum dynamic range and away from saturation; and (e) the framework is flexible enough to incorporate additional structural and connectivity constraints on the network. Other features will become apparent in view of the disclosure provided herein.

### Exemplary Computer System

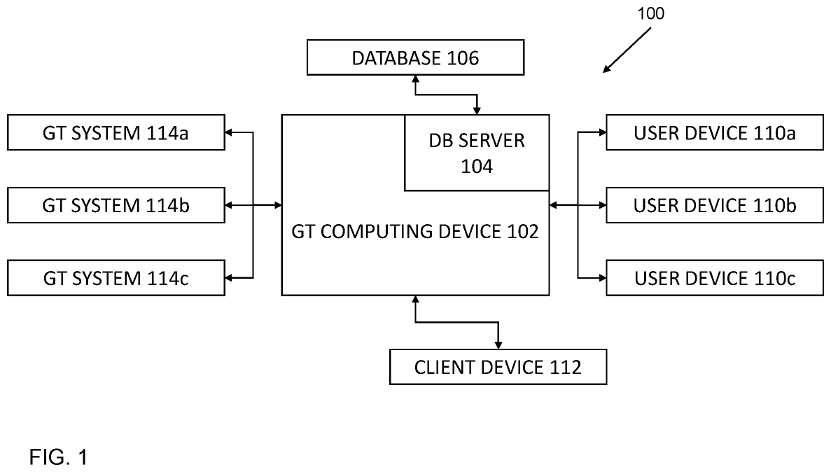

FIG. 1 depicts a simplified block diagram of an exemplary Growth Transform computing system 100. In the exemplary embodiment, system 100 may be used for designing neuromorphic tinyML systems that are constrained in energy, resources, and network structure. In the exemplary embodiment, system 100 may include a Growth Transform (GT) computing device 102 and a database server 104. GT computing device 102 may be in communication with one or more databases 106 (or other memory devices), user computing devices 110a-110c, client device 112, and/or GT network systems 114a-114c.

In the exemplary embodiment, user computing devices 110a-110c and client device 112 may be computers that include a web browser or a software application, which enables user computing devices 110a-110c or client device 112 to access remote computer devices, such as GT computing device 102, using the Internet or other network. In some embodiments, the GT computing device 102 may receive modeling data, or the like, from devices 110a-110c or 112, for the designing of GT systems 114a-114c, for example. It is understood that more, or less, than the user devices and GT systems shown in FIG. 1 may be used. The number of devices is shown is meant to be for illustrative purposes only.

In the exemplary embodiment, GT system 114a-114c may be tinyML systems, or networks, that implement machine learning processes. In some embodiments, a tinyML system may include a device that provides low latency, low power consumption, low bandwidth, and privacy. Additionally, a tinyML device, sometimes called an always on device, may be placed on the edge of a network. Example applications of a tinyML device may include, but is not limited to, smart audio speakers (e.g., Amazon Echo®, Google Home®), on-device and visual sensors (e.g., ecological, environmental), or the like. A typical tinyML device includes machine learning architecture comprised of low-power hardware and software.

More specifically, user computing devices 108 may be communicatively coupled to GT computing device 102 through many interfaces including, but not limited to, at least one of the Internet, a network, such as the Internet, a local area network (LAN), a wide area network (WAN), or an integrated services digital network (ISDN), a dial-up-connection, a digital subscriber line (DSL), a cellular phone connection, and a cable modem. User computing devices 110a-110c may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In some embodiments, user computing devices 110a-110c may transmit data to GT computing device 102 (e.g., user data including a user identifier, applications associated with a user, etc.). In further embodiments, user computing devices 110a-110c may be associated with users associated with certain datasets. For example, users may provide machine learning datasets, or the like.

A series of GT systems 114a-114c may be communicatively coupled with GT computing device 102. In some embodiments, GT systems 114a-114c may be designed and/or optimized based on machine learning techniques described herein. In some embodiments, a GT system may be a tinyML system. In some embodiments, GT systems 114a-114c may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. GT systems 114a-114c may be any type of hardware or software that can perform learning and inference at the edge of a network under energy and resource-constrained environments. For example, a GT system may comprise of a tinyML device that can run on very little power, such as a microcontroller that consumes power in the order of milliwatts or microwatts.

In some embodiments, the database 106 may store population models that may be used to design and/or optimize a GT network. For example, database 106 may store a series of learning models intended to be utilized for training neural networks to overcome one or more constraints. In some embodiments, the learning models may be neurally-relevant and backpropagation-less. Additionally, or alternatively, the trained neural network may enforce sparsity in a network's spiking activity.

Database server 104 may be communicatively coupled to database 106 that stores data. In one embodiment, database 106 may include application data, rules, application rule conformance data, etc. In the exemplary embodiment, database 106 may be stored remotely from rules engine computing device 102. In some embodiments, database 106 may be decentralized. In the exemplary embodiment, a user may access database 106 and/or rules engine computing device via user computing device 108.

### Exemplary Client Computing Device

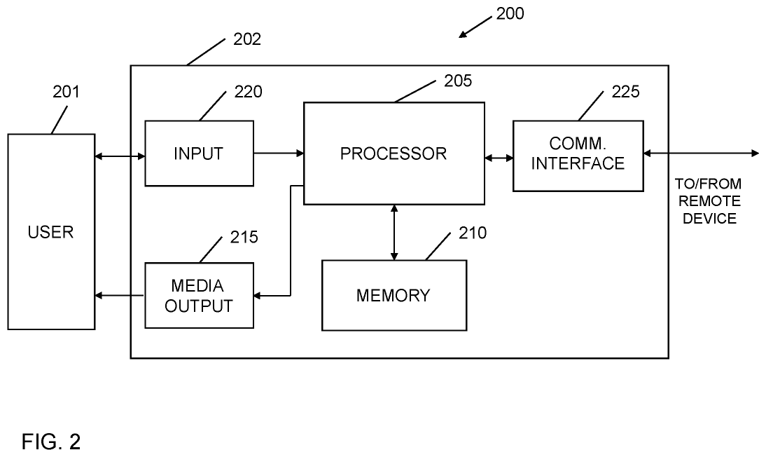

FIG. 2 illustrates a block diagram 200 of an exemplary client computing device 202 that may be used with the Growth Transform (GT) computing system 100 shown in FIG. 1. Client computing device 202 may be, for example, at least one of devices 110a-110c, 112, and 114a-114c (all shown in FIG. 1).

Client computing device 202 may include a processor 205 for executing instructions. In some embodiments, executable instructions may be stored in a memory area 210. Processor 205 may include one or more processing units (e.g., in a multi-core configuration). Memory area 210 may be any device allowing information such as executable instructions and/or other data to be stored and retrieved. Memory area 210 may include one or more computer readable media.

In exemplary embodiments, processor 205 may include and/or be communicatively coupled to one or more modules for implementing the systems and methods described herein. For example, in one exemplary embodiment, a module may be provided for receiving data and building a model based upon the received data. Received data may include, but is not limited to, training datasets that are publicly available. A model may be built upon this received data, either by a different module or the same module that received the data. Processor 205 may include or be communicatively coupled to another module for designing a GT system based upon received data.

In one or more exemplary embodiments, computing device 202 may also include at least one media output component 215 for presenting information a user 201. Media output component 215 may be any component capable of conveying information to user 201. In some embodiments, media output component 215 may include an output adapter such as a video adapter and/or an audio adapter. An output adapter may be operatively coupled to processor 205 and operatively coupled to an output device such as a display device (e.g., a liquid crystal display (LCD), a light emitting diode (LED) display, an organic light emitting diode (OLED) display, a cathode ray tube (CRT) display, an “electronic ink” display, a projected display, etc.) or an audio output device (e.g., a speaker arrangement or headphones). Media output component 215 may be configured to, for example, display a status of the model and/or display a prompt for user 201 to input user data. In another embodiment, media output component 215 may be configured to, for example, display a result of a liability limit prediction generated in response to receiving user data described herein and in view of the built model.

Client computing device 202 may also include an input device 220 for receiving input from a user 201. Input device 220 may include, for example, a keyboard, a pointing device, a mouse, a stylus, a touch sensitive panel (e.g., a touch pad or a touch screen), or an audio input device. A single component, such as a touch screen, may function as both an output device of media output component 215 and an input device of input device 220.

Client computing device 202 may also include a communication interface 225, which can be communicatively coupled to a remote device, such as GT computing device 102, shown in FIG. 1. Communication interface 225 may include, for example, a wired or wireless network adapter or a wireless data transceiver for use with a mobile phone network (e.g., Global System for Mobile communications (GSM), 3G, 4G, or Bluetooth) or other mobile data networks (e.g., Worldwide Interoperability for Microwave Access (WIMAX)). The systems and methods disclosed herein are not limited to any certain type of short-range or long-range networks.

Stored in memory area 210 may be, for example, computer readable instructions for providing a user interface to user 201 via media output component 215 and, optionally, receiving and processing input from input device 220. A user interface may include, among other possibilities, a web browser or a client application. Web browsers may enable users, such as user 201, to display and interact with media and other information typically embedded on a web page or a website.

Memory area 210 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAN). The above memory types are exemplary only, and are thus not limiting as to the types of memory usable for storage of a computer program

### Exemplary Server Computing System

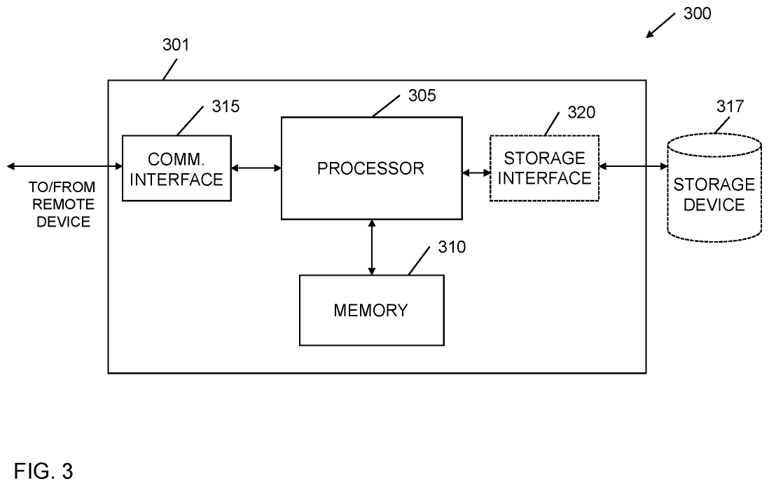

FIG. 3 depicts a block diagram 300 showing an exemplary server system 301 that may be used with the GT system 100 illustrated in FIG. 1. Server system 301 may be, for example, GT computing device 102 or database server 104 (shown in FIG. 1).

In exemplary embodiments, server system 301 may include a processor 305 for executing instructions. Instructions may be stored in a memory area 310. Processor 305 may include one or more processing units (e.g., in a multi-core configuration) for executing instructions. The instructions may be executed within a variety of different operating systems on server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C #, C++, Java, or other suitable programming languages, etc.).

Processor 305 may be operatively coupled to a communication interface 315 such that server system 301 is capable of communicating with GT computing device 102, user devices 110a-110c, 112, and 114a-114c (all shown in FIG. 1), and/or another server system. For example, communication interface 315 may receive data from user devices 110a-110c, 112 and 114a-114c via the Internet.

Processor 305 may also be operatively coupled to a storage device 317, such as database 106 (shown in FIG. 1). Storage device 317 may be any computer-operated hardware suitable for storing and/or retrieving data. In some embodiments, storage device 317 may be integrated in server system 301. For example, server system 301 may include one or more hard disk drives as storage device 317. In other embodiments, storage device 317 may be external to server system 301 and may be accessed by a plurality of server systems. For example, storage device 317 may include multiple storage units such as hard disks or solid-state disks in a redundant array of inexpensive disks (RAID) configuration. Storage device 317 may include a storage area network (SAN) and/or a network attached storage (NAS) system.

In some embodiments, processor 305 may be operatively coupled to storage device 317 via a storage interface 320. Storage interface 320 may be any component capable of providing processor 305 with access to storage device 317. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 317.

Memory area 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer system.

### Growth Transform Neural Networks

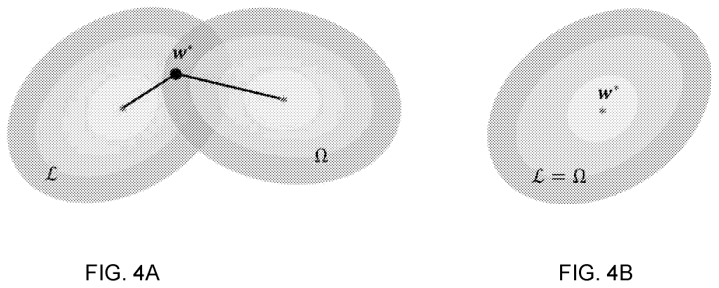

As shown in FIG. 4A, energy-efficiency in energy-based neuromorphic machine learning, there is a loss function for training and an additional loss for enforcing sparsity. The embodiments set forth herein make the loss for training and loss for enforcing sparsity equal, as shown in FIG. 4B.

In some embodiments, a framework for designing neuromorphic tinyML systems that are backpropagation-less but are also able to enforce sparsity in network spiking activity in addition to conforming to additional structural or connectivity constraints imposed on the network is provided. The disclosed framework, in some embodiments, may build upon a spiking neuron and population model based on a Growth Transform dynamical system, for example, where the dynamical and spiking responses of a neuron may be derived directly from an energy functional of continuous-valued neural variables (e.g., membrane potentials). This may provide the model with enough granularity to independently control different neuro-dynamical parameters (e.g., the shape of action potentials or transient population dynamics like bursting, spike frequency adaptation, etc.). In some embodiments, the framework may incorporate learning or synaptic adaptation in determining an optimal network configuration. Further, inherent dynamics of Growth Transform neurons may be exploited to design networks where learning the optimal parameters for a learning task simultaneously minimizes an energy metric for a system (e.g., the sum-total of spiking activity across the network).

As shown in FIG. 4B, the energy function for reducing the training error also represents the network-level spiking activity, such that minimizing one is equivalent to minimizing the other. Further, since the energy functionals for deriving the optimal neural responses as well as weight parameters are directly expressible in terms of continuous-valued membrane potentials, the Growth Transform (GT) neuron model may implement energy-based learning using the neural variables themselves, without requiring to resort to rate-based representations, spike-time conversions, output approximations or the user of external classifiers. Alternatively, or additionally, some embodiments include a multi-layered network architecture where lateral connections between layers may remain static. This may allow for the design of networks where weight adaptation only happens between neurons on the same layer, which may be locally implemented on hardware. Even further, some embodiments may include that the sparsity constraints on the network's spiking activity acts as a regularizer that improves the Growth Transform neural network's (GTNN's) generalization performance when learning with few training samples (i.e. few-shot learning).

In the present embodiments as shown and described with respect to a Growth Transform neural network (GTNN), an energy function may be derived for minimizing the average power dissipation in a generic neuron model under specified constraints. In some embodiments, spike generation may be framed as a constraint violation in such a network. Further, the energy function may be optimized using a continuous-time Growth Transform dynamical system. Properties of GT neurons may be exploited to design a differential network configuration consisting of ON-OFF neuron pairs which always satisfies a linear relationship between the input and response variables. A learning framework may adapt weights in the network such that the linear relationship is satisfied with the highest network sparsity possible (i.e., the minimum number of spikes elicited across the network). Present embodiments may also include appropriate choices of network architecture to solve standard unsupervised and supervised machine learning tasks using the GT network, while simultaneously optimizing for sparsity. Previous results may be used to solve non-linearly separable classification problems using three different end-to-end spiking networks with progressively increasing flexibility in training and sparsity.

### Learning Framework

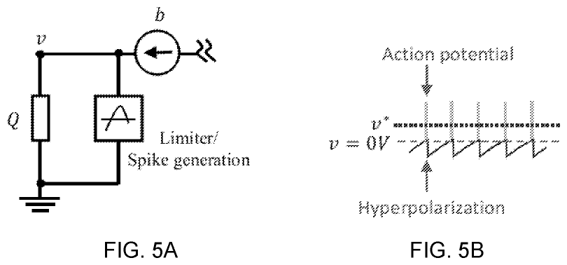

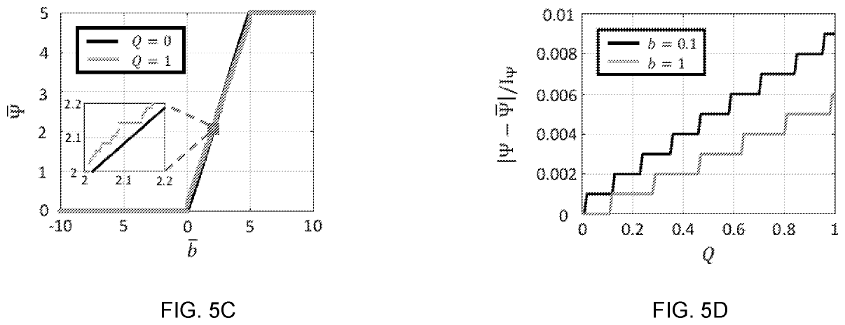

FIG. 5A illustrates an example circuit model for a single neuron model with external current input. For example, an intra-cellular membrane potential of the single neuron may be denoted by ν∈ [symbol] . The single neuron may receive an external stimulus as current input b. The instantaneous power may be denoted by P∈ [symbol] and may be given by:

P=(Qν−b)ν, (1)

where Q∈ [symbol] ⁺ captures the effect of leakage impedance, as shown in FIG. 5A. Biophysical constraints that the membrane potential ν may be bounded as:

−ν_{c}≤ν≤0, (2)

where V_{c}>0 V is a constant potential acting as a lower-bound, and 0 V is a reference potential acting as a threshold voltage. In some embodiments, minimizing the average power dissipation of the neuron under the bound constraint in (2) is equivalent to solving the following optimization problem:

$${min}_{- {v}_{c} \leq v \leq 0} P = {min}_{- {v}_{c} \leq v \leq 0} \frac{1}{2} {Qv}^{2} - bv , \qquad ( 3 )$$

Let Ψ≥0 be the KKT (Karush-Kuhn-Tucker) multiplier corresponding to the inequality constraint ν≤0, then the optimization in (3) is equivalent to:

$${min}_{\vert v \vert \leq {v}_{c} , Ψ} ℋ ( v ) = {min}_{\vert v \vert \leq {v}_{c} , Ψ} \frac{1}{2} {Qv}^{2} - Ψ v , \qquad ( 4 )$$

where Ψ≥0, and Ψν*=0 satisfy the KKT complementary slackness criterion for the optimal solution ν*. The solution to the optimization problem in (4) satisfies the following first-order condition:

Ψ=−Qv*+b

Ψν*=0;Ψ≥0;|ν*|≤ν_{c} (5)

The first-order condition in (5) may be extended to a time-varying input b(t) where (5) can be expressed in terms of a temporal expectation (see Table 1) of the optimization variables as:

Ψ̅−Qν̅+b̅

Ψν=0;Ψ≥0;|ν|≤ν_{c} (6)

The KKT constraints Ψν=0; Ψ≥0 need to be satisfied for all instantaneous values and at all times, and not only at the optimal solution ν*. Thus, Ψ may act as a spiking function which results from the violation of the constraint ν≤0. In some embodiments, a dynamical system with a specific form of Ψ may naturally define the process of spike-generation.

In order to satisfy the first-order conditions (6) using a dynamical systems approach, Ψ may be defined as a barrier function:

$$Ψ ( v ) = \{ \begin{matrix}{I}_{Ψ} ; v > 0 \\ 0 ; v \leq 0\end{matrix} \} , \qquad ( 7 )$$

with I_{Ψ}≥0 denoting a hyperpolarization parameter. Such a barrier function may ensure that a complementary slackness condition holds at all times. The temporal expectation Ψ̅→Ψ is shown in the limit as Q→0. For the form of the spike function in (7):

Ψν=∫_{-∞}^{ν}Ψ(η)dη, (8)

Thus, the optimization problem in (9) may be rewritten as:

$$τ ( t ) \frac{dv}{dt} + v = {v}_{c} \frac{- {gv}_{c} + λ v}{- gv + λ {v}_{c}} , \qquad ( 10 )$$

A cost function [symbol] may be optimized using a dynamical systems approach similar to a Growth Transform (GT) neuron model. For the GT neuron, the membrane potential ν evolves according to the following first-order non-linear differential equation:

$$τ ( t ) \frac{dv}{dt} + v = {v}_{c} \frac{- {gv}_{c} + λ v}{- gv + λ {v}_{c}} , \qquad ( 10 )$$

where

g=Qν−b+Ψ (11)

Here, λ is a fixed hyper-parameter that is chosen such at λ>|g|, and 0≤τ(t)<∞ is a modulation function that may be tuned individually for each neuron and models the excitability of the neuron to external stimulation. FIG. 5B illustrates example oscillatory dynamics in a GT neuron model when an optimal solution goes above the spike threshold and the composite spike signal upon addition of spikes. As shown in FIG. 5B, a sample membrane potential and spike function trace of a single GT neuron in response to a fixed stimulus is illustrated. The neuron model has a spiking threshold at 0 V, which corresponds to the discontinuity in the spike function Ψ. When the neuron receives a positive input, the optimal solution ν, indicated by ν* in FIG. 5B, shifts above the threshold to a level that is a function of the stimulus magnitude. When ν tries to exceed the threshold in an attempt to reach the optimal solution, Ψ penalizes the energy functional, forcing ν to reset below the threshold. The stimulus and the barrier function may introduce opposing tendencies as long as the stimulus is present, making ν oscillate back and forth around the discontinuity (i.e. spike threshold). During the brief period when ν reaches the threshold, the neuron may enter in a runaway state leading to a voltage spike, shown by gray bars in FIG. 5B. In some embodiments, a modulation function may provide another degree of freedom that may be varied to model different transient firing statistics based on local and/or global variables. For example, the modulation function may be varied based on local variables, such as membrane potentials or local firing rates, to reproduce single-neuron response characteristics like tonic spiking, bursting, spike-frequency adaptation, etc., or based on global properties like the state of convergence of the network to yield different population-level dynamics.

Orthogonal and ReLU encoding of a single GT neuron will now be described. Since Ψ≥0 and Ψν*=0, the first order condition in (5) gives:

Ψ=ReLU(b), (12)

where

$$Re LU ( z ) = \{ \begin{matrix}z ; z > 0 \\ 0 ; z \leq 0\end{matrix} \} \qquad ( 13 )$$

FIG. 5C illustrates a plot for different values of Q. FIG. 5C shows that Ψ̅ approximates Ψ when the external input bᵢ is varied, for two different values of Q. Since I_{Ψ} also controls the refractory period of the GT neuron and the temporal expectation is computed over a finite time window, there exists an upper-bound on the maximum firing rate as shown in FIG. 5C. Ψ may correspond to discrete events, thus the result (12) may exhibit quantization effects. In the limit Q→0, Ψ̅ may converge towards the floating-point parameter satisfying the KKT condition. FIG. 5D illustrates an example error introduced as a result of approximating with respect to different values of Q and two different current inputs. FIG. 5D plots the absolute difference between Ψ and Ψ̅ (normalized by I_{Ψ}) for different values of the leakage impedance. The quantization step of 0.001 in the plot arises due to a finite number of spikes that may occur within a finite window size (1000 time-steps for the plot shown). The quantization error may be further reduced by considering a larger window size. The variables Ψ and ν and their temporal expectations may be used interchangeably with the understanding that they converge towards each other in the limit Q→0. Further, an indicator function may be obtained by normalizing a spike magnitude, s=Ψ/I_{Ψ}, to denote a binary spike event.

In at least one embodiment, the response of a single GT neuron from the first-order condition in (6) is:

Ψ+Qν=b (14)

Ψ_{ν}=0, (15)

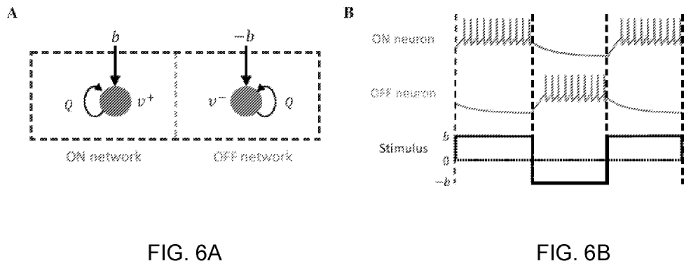

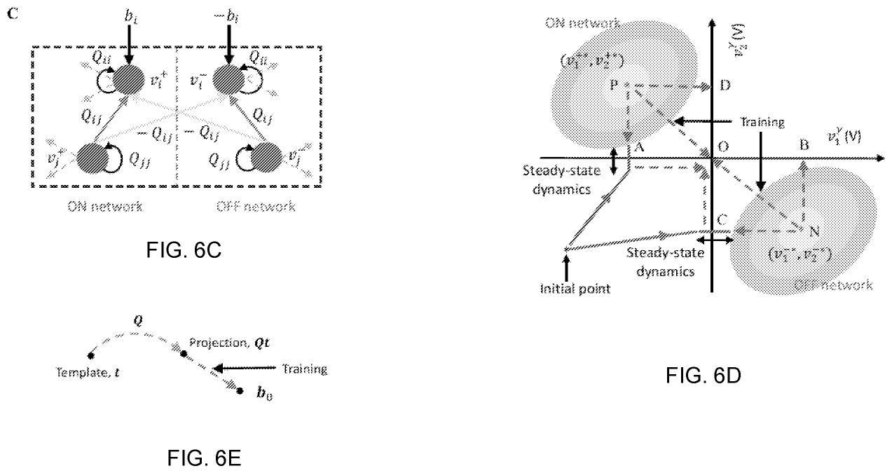

An ON-OFF GT neuron model for stimulus encoding will now be described. A fundamental building block in the disclosed GTNN learning framework is an ON-OFF GT neuron model. An example GT network is shown in FIG. 6A. The GT network may comprise of a pair of neurons, such as an ON neuron and an OFF neuron. The membrane potentials of the ON neuron and OFF neuron are denoted as ν⁺ and ν⁻, respectively. An external input b may be presented differentially to the neuron pair, where the ON neuron receives a positive input stimulus b and the OFF neuron receives a negative input stimulus −b. For simplicity, it is assumed in this example that the neurons do not have any synaptic projections towards each other, as shown in FIG. 6A. The optimization problem (4) may decompose into two uncoupled cost functions corresponding to the ON and OFF neurons respectively as:

$${min}_{\vert {v}^{+} \vert \leq {v}_{c}} ℋ ( {v}^{+} ) = {min}_{\vert {v}^{+} \vert \leq {v}_{c}} \frac{1}{2} {Qv}^{{+}^{2}} - b {v}^{+} + {Ψ}^{+} {v}^{+} , and \qquad ( 16 )$$

$${min}_{\vert {v}^{-} \vert \leq {v}_{c}} ℋ ( {v}^{-} ) = {min}_{\vert {v}^{-} \vert \leq {v}_{c}} \frac{1}{2} {Qv}^{{-}^{2}} + b {v}^{-} + {Ψ}^{-} {v}^{-} \qquad ( 17 )$$

This corresponds to the following first-order conditions for the differential pair:

Qν⁺+Ψ⁺=b, and (18)

Qν⁻+Ψ⁻=−b, (19)

along with the non-negativity and complementary conditions for the respective spike functions:

Ψ⁺≥0;Ψ⁺ν⁺=0, and

Ψ⁻≥0;Ψ⁻ν⁻=0. (20)

Case 1. b≥0: When b is positive, the following solutions to (18) and (19) may be obtained under the above constraints:

ν⁺=0,Ψ⁺=b, and (21)

Qν⁻=−b,Ψ⁻=0. (22)

Case 2. b<0: When b is negative, the corresponding solutions are as follows:

Qν⁺=b,Ψ⁺=0, and (23)

ν⁻=0,Ψ⁻=−b. (24)

Based on the two cases, the ON-OFF variables ν⁺ and ν⁻ satisfy the following properties:

ν⁺ν⁻=0, (25)

Q(ν⁺−ν⁻)=Ψ⁺−Ψ⁻=b (26)

Ψ⁺+Ψ⁻=−Q(ν⁺+ν⁻). (27)

Property (25) illustrates that the membrane voltage vectors ν⁺ and ν⁻ are always orthogonal to each other. FIG. 6B shows that the orthogonal also holds for their respective temporal dynamics as well when the input stimulus is turned ON and OFF. Property (26) shows that the ON-OFF network in conjunction with each other faithfully encodes the input stimuli. In this regard, the network may behave as an analog-to-digital converter which maps the time-varying analog input into a train of output binary spikes. Property (27) in conjunction with Property (25) leads to:

(Ψ⁺+Ψ⁻)=−Q(ν⁺+ν⁻) (28)

=Q∥(ν⁺+ν⁻)∥₁ (29)

which states that the average spiking rate of an ON-OFF network encodes the norm of the differential membrane potential ν=ν⁺−ν⁻. This property may be used to simultaneously enforce sparsity and solve a learning task.

A sparsity-driven learning framework to adapt Q is now described. The above-described ON-OFF neuron pair may be extended to a generic network comprising M neuron pairs, as shown in FIG. 6C. The i-th neuron pair may be coupled differentially to the j-th neuron pair through a trans-conductance synapse denoted by its weight Qᵢⱼ∈ [symbol] The differential stimuli bᵢ to the ON-OFF network in (18) and (19) may be generalized as

$${b}_{i}^{′} ← {b}_{i} - {\sum }_{j \neq i} {Q}_{ij} ( {v}_{j}^{+} - {v}_{j}^{-} ) \qquad ( 30 )$$

when may then lead to the first-order conditions for the i-th ON-OFF neuron pair as:

$${Q}_{ii} {v}_{i}^{+} + {Ψ}_{i}^{+} = - {\sum }_{j \neq i} {Q}_{ij} ( {v}_{j}^{+} - {v}_{j}^{-} ) + {b}_{i} , and \qquad ( 31 )$$

$${Q}_{ii} {v}_{i}^{-} + {Ψ}_{i}^{-} = {\sum }_{j \neq i} {Q}_{ij} ( {v}_{j}^{+} - {v}_{j}^{-} ) - {b}_{i} . \qquad ( 32 )$$

Each neuron in the network satisfies:

$${Q}_{ii} ( {v}_{i}^{+} - {v}_{i}^{-} ) + {b}_{i}^{′} , or \qquad ( 33 )$$

$${Q}_{ii} ( {v}_{i}^{+} - {v}_{i}^{-} ) + {b}_{i} - {\sum }_{j \neq i} {Q}_{ij} ( {v}_{j}^{+} - {v}_{j}^{-} ) , or \qquad ( 34 )$$

$${\sum }_{j = 1}^{M} {Q}_{ij} ( {v}_{j}^{+} - {v}_{j}^{-} ) = {b}_{i} \qquad ( 35 )$$

Equation (35) may be written in a matrix form as a linear constraint:

Qν=b. (36)

The linear constraint (36) arose as a result of each neuron optimizing its local power dissipation as:

$${min}_{{v}_{i}^{+} , {v}_{i}^{-}} ℋ ( {v}_{i}^{+} ) + ℋ ( {v}_{i}^{-} ) , \qquad ( 37 )$$

with the synaptic connections being modeled by the matrix Q. In addition to each of the neurons minimizing its respective power dissipation with respect to the membrane potentials, the total spiking activity of the network may be minimized with respect to the synaptic strengths as:

$${min}_{{Q}_{ij}} ℒ ( {Q}_{ij} ) = {min}_{{Q}_{ij}} {\sum }_{i = 1}^{M} ( {Ψ}_{i}^{+} + {Ψ}_{i}^{-} ) . \qquad ( 38 )$$

In view of (29),

$${min}_{{Q}_{ij}} ℒ ( {Q}_{ij} ) ⟹ {min}_{{Q}_{ij}} {‖ v ‖}_{1} . \qquad ( 39 )$$

Solving optimization problems in (37) and (38) simultaneously is equivalent to solving the following L₁ optimization:

$${min}_{Q} {‖ v ‖}_{1} \qquad ( 40 )$$

$$s . t . Qv = b .$$

The L₁ optimization bears similarity to compressive sensing formulations. In this embodiment, the objective is to find the sparsest membrane potential vector by adapting the synaptic weight matrix in a manner that the information encoded by the input stimuli is captured by the linear constraint. The rules out the trivial sparse solution ν*=0 for a non-zero input stimuli. A gradient descent approach is applied to the cost function in (38) to update the synaptic weight Qᵢⱼ according to:

$$Δ {Q}_{ij} = - η \frac{\partial ℒ}{\partial {Q}_{ij}} , \qquad ( 41 )$$

where n>0 is the learning rate. Using the property (12), one obtains the following spike-based local update rule:

ΔQᵢⱼ=ηΨᵢ⁺(νⱼ⁺−νⱼ⁻)−Ψᵢ⁻(νⱼ⁺−νⱼ⁻) (42)

=−η(Ψᵢ⁺−Ψᵢ⁻)(νⱼ⁺−νⱼ⁻) (43)

By construction ΔQᵢⱼ=0, implying that the self-connections in GTNN do not change during the adaptation. Also, the synaptic matrix Q need not be symmetric which makes the framework more general than conventional energy-based optimization.

FIG. 6D pictorially depicts how the sparsest solution is achieved through firing rate minimization for a differential network M=2. In this example, the matrix Q is symmetric and the solution can be visualized using energy contours. FIG. 6D shows energy contours in absence of the barrier function for the positive and negative parts of the network superimposed on the same graph. The presence of barrier function prohibits the membrane potentials from reaching the optimal solutions. The membrane potentials exhibit steady-state spiking dynamics around the spike thresholds. These steady-state dynamics may correspond to positive and negative networks as shown in FIG. 6D as black lines at points A and C where the two coupled networks breach the spiking threshold under the respective energy contours in steady-state.

During weight adaptation, for example, network weights may evolve such that the membrane potentials breach the spiking threshold less often, which essentially pushes the optimal solution for the positive network towards A. Since the two networks may be differential, the optimal solution for the negative network may be pushed towards B. Similarly, during weight adaptation, an optimal solution for the negative network may be pushed towards C such that its own spike threshold constraints are violated less frequently, which in turn pushes the optimal solution for the positive network towards D. The positive network may therefore move towards a path P-0 given by the vector sum of paths PD and PA. Similarly, the negative network may move toward the path NO, given by the vector sum of paths NC and NB. This may minimize the overall firing rate of the network and drives the membrane potentials of each differential pair towards zero, while simultaneously ensuring that the linear constraint in (36) is always satisfied.

Linear projection using a sparse GT network will now be described. The L₁ optimization framework described by (40 provides a mechanism to synthesize and understand the solution of GTNN variants. For example, if input stimulus vector b is replaced by:

b=b₀−Qt. (44)

where t∈ [symbol] ^{M} is a fixed template vector then according to (4), the equivalent L₁ optimization leads to:

$${min}_{Q} {‖ v ‖}_{1} s . t . Qv = {b}_{0} - Qt . \qquad ( 45 )$$

The nature of the L₁ optimization chooses the solution Qt=b0 such that ∥ν∥₁→0. Thus,

$${min}_{Q} {‖ v ‖}_{1} ⟹ {min}_{Q} {‖ {b}_{0} - Qt ‖}_{1} . \qquad ( 46 )$$

The synaptic update rule corresponding to the modified loss function is given by:

ΔQᵢⱼ=η₇(Ψᵢ⁺−Ψᵢ⁻)(νⱼ⁺−νⱼ⁻+tⱼ). (47)

The above is depicted in FIG. 6E, which shows that the projection template vector, Qt, evolves towards b₀ with synaptic adaptation. This may be used to solve unsupervised learning problems like domain description and anomaly detection, for example.

Inference using network sparsity will now be described. Sparsity in network spiking activity may be directly used for optimal inference. The rationale is that L₁ optimization in (40) and (45) chooses the synaptic weights Q that may exploit the dependence (statistical or temporal) between the different elements of the stimulus vector b to reduce the norm of membrane potential vector ∥ν∥₁ and hence the spiking activity. The process of inference involves choosing the stimulus that produces the least normalized network spiking activity defined as:

$${arg}_{b} min {ρ}_{b} = \frac{1}{2 M} {\sum }_{i = 1}^{M} ( {s}_{{b}_{i}}^{+} + {s}_{{b}_{i}}^{-} ) , \qquad ( 48 )$$

where M denotes the total number of differential pairs in the network and s+ and s− are the average spike counts of the i-th ON-OFF pair when the stimulus b is presented as input.

### Application of Learning Framework Machine Learning

Application of the learning framework described above will now be described with respect to standard machine learning tasks. Different choices of neural parameters and network architectures lend themselves to solving standard unsupervised and supervised learning problems.

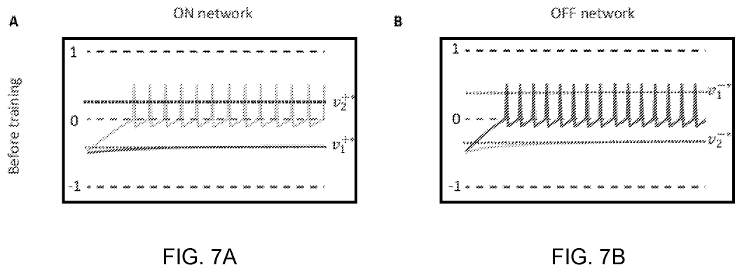

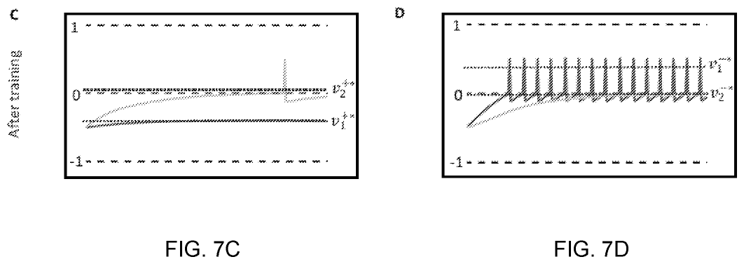

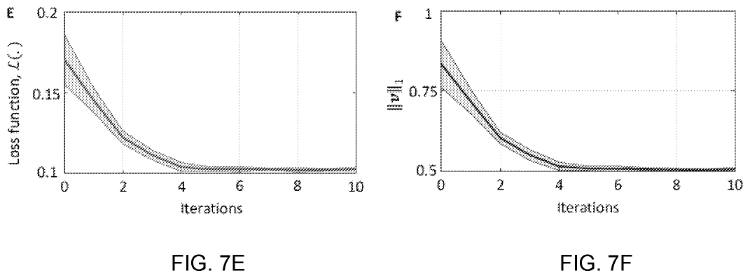

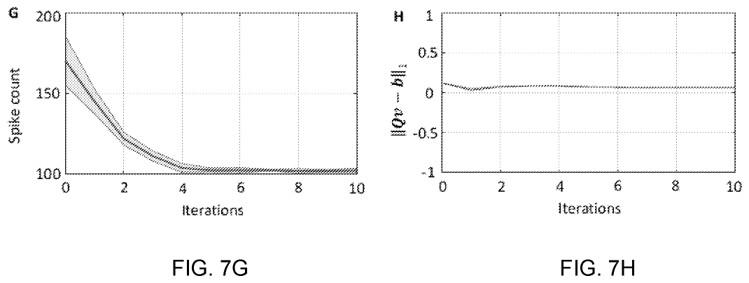

Weight adaptation and how it leads to sparsity will now be described in view of FIGS. 7A and 7B. FIGS. 7A and 7B illustrate a sparsity-driven weight adaptation using a differential network with two neuron pairs presented with a constant external input vector. As shown, spike response may correspond to the ON and OFF networks respectively, before any weight adaptation has taken place. FIGS. 4C and 4D show the same plots post-training. For example, training evolves the weights such that as many elements of the vector of membrane potentials as possible can approach zero while the network still satisfies the linear constraint in (36). The weight adaptation may be accompanied by a decline in the firing rates for neuron pair 2, while firing rates for neuron pair 1 remains largely unchanged. This may be expected for a network with two differential pairs, since at least one neuron pair needs to spike in order to satisfy (36). FIGS. 7E-7G plot the decrease in cost function, ∥ν∥₁ and total spike count across the network respectively as weight adaptation progresses. FIG. 7H shows that ∥Qν−b∥₁ remains close to zero throughout the training process. For FIGS. 7E-7H, solid lines indicate mean values across five runs with different initial conditions, while the shaded regions indicate standard deviation about the mean.

Unsupervised learning using a template projection will now be described. In this example, unsupervised machine learning tasks may be formulated, such as domain description and anomaly detection, as a template projection problem. In this example, let xₖ∈ [symbol] , k=1, . . . , K, be data points drawn independently from a fixed distribution P(x) where D is the dimension of the feature space, and let t∈ [symbol] be a fixed template vector. Then from (46), weight adaptation gives:

$${min}_{{Q}_{ij}} ℒ ( {Q}_{ij} ) ⟹ {min}_{{Q}_{ij}} \frac{1}{K} {\sum }_{k = 1}^{K} {‖ Qt - {x}_{k} ‖}_{1} , \qquad ( 49 )$$

Minimizing the network-level spiking activity evolves weights in the transformation matrix Q such that the projection of the template vector can represent the given set of data points with the minimum mean absolute error.

In a domain description problem, a set of objects or data points given by a training set may be described so as to distinguish from all other data points in the vector space. Using the above described template projection framework, a GT network may be trained to evolve towards a set of data points such that its overall spiking activity is lower for these points, indicating that it is able to describe the domain and distinguish it from others.

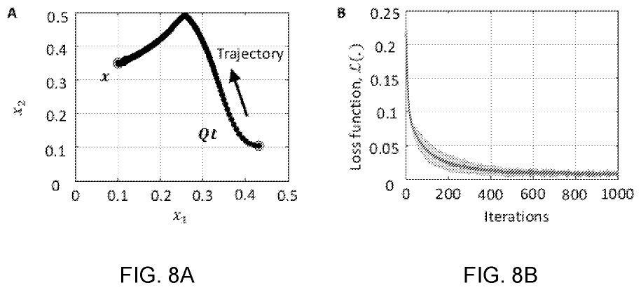

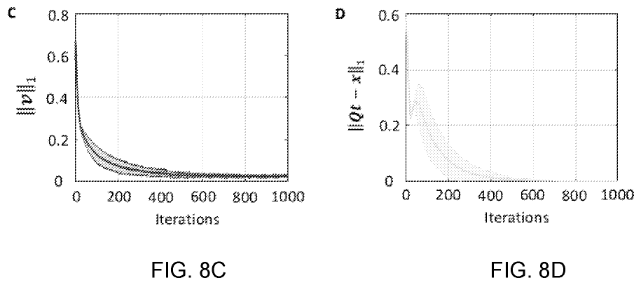

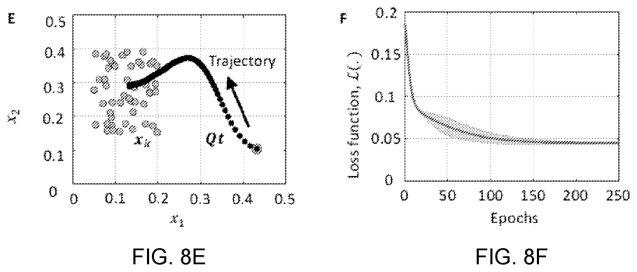

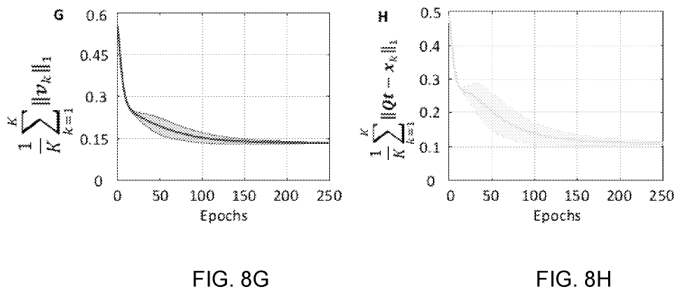

For example, the equivalence between firing rate minimization across the network and loss minimization in (49) for a series of problems where D=2 is shown. The simplest case with a single data point and a fixed threshold vector is shown in FIG. 8A. As training progresses, Qt evolves along the trajectory shown by black dots from the initial condition indicated by a green circle towards the data point indicated by a circle. FIG. 8B plots the mean and standard deviation of the loss function for the problem in FIG. 8A across five experiments with randomly selected initial conditions. The average loss decreases with the number of training iterations until a small baseline firing rate is reached upon convergence. FIGS. 8C and 8D plot the corresponding L₁ norm of the vector of mean membrane potentials and the L₁ loss in (49) respectively. The L₁ loss goes to zero with training, while ∥ν∥₁ approaches near zero. FIG. 8E shows a case when the network is trained with multiple data points in an online manner. The network trajectory in this example evolves from the initial point to a point that lies near the median of the cluster. FIGS. 8F-8H show corresponding plots for the loss function, L₁ norm of mean membrane potential vector and the L₁ loss in (49) versus epochs, where one epoch refers to training the network on all points in the dataset once in a sequential manner. A single template vector attempts to explain or approximate all data points in the cluster. The L₁ loss in FIG. 8H does not reach zero. However, the network adapts its weights such that is responds with the fewest number of spikes overall for the data points it sees during training, such that the network-level spiking activity is minimized for the dataset.

Anomaly detection will now be described. The unsupervised loss minimization framework described above drives the GT network to spike less when presented with a data point it has seen during training in comparison to an unseen data point. This may be may extended seamlessly to apply to outlier or anomaly detection problems. When the network is trained with an unlabeled training set, for example, it adapts its weights so that it fires less for data points it sees during training, referred to as members, and fires more for points that are far away, or dissimilar, to them, referr3ed to as anomalies. Template vectors, for example, may be random-valued vectors held constant throughout the training procedure.

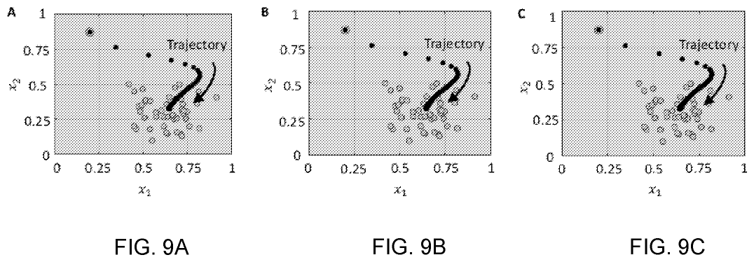

Subsequent to training, mean firing rates of the network for each data point may be determined in the training dataset. Further, the maximum mean firing rate may be set as the threshold. During inference, any data point that causes the network to fire at a rate equal to or lower than this threshold may be considered a member, otherwise it is considered an outlier or an anomaly. In FIG. 9, circles correspond to the training data points. Based on the computing firing threshold, the network may learn to classify data points similar to the training set as members, as shown in FIG. 9A. The firing rate threshold may be tuned appropriately in order to reject a pre-determined fraction of training data points as outliers. FIGS. 9B and 9C show the contraction in the domain described by the anomaly detection network when the threshold is progressively reduced to rejection 25% and 50% of the training data points as outliers.

Supervised learning will now be described. In an example embodiment, a framework outlined in (40), a network is designed that can solve linear classification problems using a GT network. For example, a binary classification problem given by a training dataset (xₖ,yₖ), k=1, . . . , K, drawn independently from a fixed distribution P(x,y) defined over [symbol] x {−1, +1}. The vector xₖ is denoted as the k-th training vector and yₖ is the corresponding binary label indicating class membership (+1 or −1). In this example, two network architectures for solving this problem may be used. The first may be a minimalist feed-forward network. The second may be a fully-connected recurrent network. Additionally, properties of the two architectures may be compared.

A linear feed-forward network will now be described. A loss function for solving a linear classification problem may be defined as follows:

$${min}_{{a}_{i} , b} {ℒ}_{linear} = {min}_{{a}_{i} , b} \vert y - {\sum }_{i = 1}^{D} {a}_{i} {x}_{i} - b \vert \qquad ( 50 )$$

where aᵢ∈R, i=1, . . . , D, and the output neuron pair may be denoted by (y⁺, y⁻). The network may also have a bias neuron denoted by (b⁺, b⁻) which received a constant positive input. equal to 1 for each data point. In some embodiments, feed-forward synaptic connections from the feature neuron pairs to the output neuron pair are then given by:

Q_{yi}=aᵢ,i=1, . . . ,D,

Q_{yb}=b. (51)

Self-synaptic connections Qᵢᵢ may be kept constant at 1 throughout training, while all remaining connections are set to zero. When a data point is presented, (x,y), to the network, from (35) then:

(νᵢ⁺−νᵢ⁻)=xᵢ,i=1, . . . ,D, and (52)

(ν_{b}⁺−νb⁻)=1. (53)

For the output neuron pair, then:

$${v}_{y}^{+} - {v}_{y}^{-} = y - {\sum }_{j \neq y} {Q}_{ij} ( {v}_{j}^{+} - {v}_{j}^{-} ) = y - {\sum }_{i = 1}^{D} {a}_{i} ( {v}_{i}^{+} - {v}_{i}^{-} ) - b ( {v}_{b}^{+} - {v}_{b}^{-} ) = y - {\sum }_{i = 1}^{D} {a}_{i} {x}_{i} - b . \qquad ( 54 )$$

Minimizing the sum of mean firing rates for the output neuron pair gives:

$${min}_{{Q}_{yi} , {Q}_{yb}} {ℒ}_{ff} ( {Q}_{yi} , {Q}_{yb} ) = {min}_{{Q}_{yi} , {Q}_{yb}} ( {Ψ}_{y}^{+} + {Ψ}_{y}^{-} ) = {min}_{{Q}_{yi} , {Q}_{yb}} \vert {v}_{y}^{+} - {v}_{y}^{-} \vert = {min}_{{a}_{i} , b} \vert y - {\sum }_{i = 1}^{D} {a}_{i} {x}_{i} - b \vert = {min}_{{a}_{i} , b} {ℒ}_{linear} \qquad ( 55 )$$

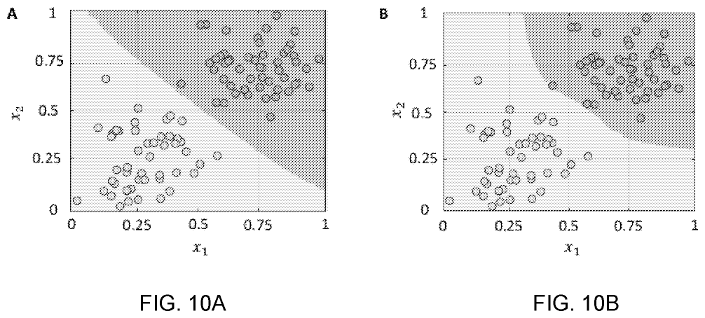

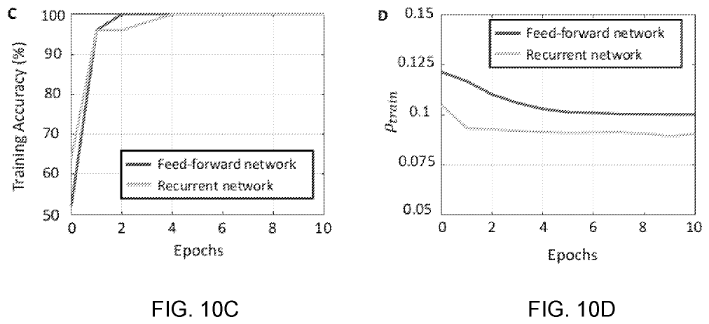

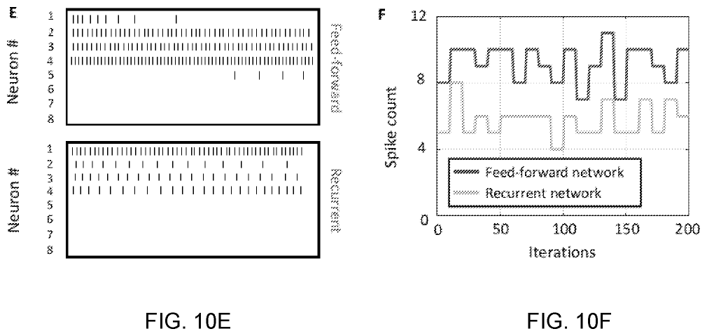

A linear classification framework with a feed-forward architecture is verified in FIG. 10A for a synthetic two-dimensional binary dataset. In one example, the training data points belong to the two classes described above and are shown as circles. During inference, possible labels may be presented to the network along with each test data point. Further, the data point may be assigned to a class that produces the least number of spikes across the output neurons, according to the above described inference procedure. Also shown in FIG. 10A is a classification boundary produced by the GT network after training.

A linear recurrent network will now be described. In another example, a fully-connected network architecture for linear classification is provided. In this example, the feature and bias neuron pairs are not only connected to the output pair, but to each other. Additionally, trainable recurrent connections from the output pair to the rest of the network may be implemented. From (35), the following may be used:

Qν=x′, (56)

where x′=[y, x₁, x₂, . . . , x_{D}, 1]^{T} is the augmented vector of inputs. The following optimization problem is solved for the recurrent network, which minimizes sum of firing rates for all neuron pairs across the network:

$${min}_{{Q}_{ij}} {ℒ}_{fc} ( {Q}_{ij} ) = {min}_{{Q}_{ij}} {\sum }_{i = 1}^{M} ( {Ψ}_{i}^{+} + {Ψ}_{i}^{-} ) . \qquad ( 57 )$$

In some embodiments, weight adaptation in a fully-connected network ensures that (56) is satisfied with a minimum norm on the vector of membrane potentials (i.e., the lowest spiking activity across the network, as opposed to enforcing the sparsity constraint only on the output neuron pair in the previous example). The inference process may then proceed as before by presenting each possible label to the network and assigning the data point to the class that produces the least number of spikes across the network.

FIG. 10B shows the classification boundary produced by a fully-connected network for the same two-dimensional binary dataset. Both networks are able to classify the dataset, although the final classification boundaries may be slightly different. FIG. 10C plots training accuracy versus number of epochs for the two networks, where each epoch refers to training on the entire dataset once. For comparing how the network-level spiking activity evolves with training for the two networks, the sparsity metric of (48) is averaged over the training dataset:

$${ρ}_{train} = \frac{1}{2 MK} {\sum }_{k = 1}^{K} {\sum }_{i = 1}^{M} ( {s}_{{b}_{ki}}^{+} + {s}_{{b}_{ki}}^{-} ) , \qquad ( 58 )$$

where s+ and s− are mean spike counts of the i-th ON-OFF pair when the k-th training data point is presented to the network along with the correct label. FIG. 10D plots how the metric evolves with the number of training epochs for the two networks. Although the fully-connected network may have a considerably higher number of non-zero synaptic connections, the final network firing activity after training has converged is much lower than the feed-forward network, indicating that it is able to separate the classes with a much lower network-level spiking activity across the entire training dataset. FIGS. 10E and 10F show the spike rasters and post-stimulus time histogram (PSTH) curves for one representative training data point corresponding to the feed-forward and fully-connected networks respectively, after the weights have converged for both networks. In some embodiments, the total spike count across the network may be much lower for the fully-connected network.

Multi-layer spiking GTNN will now be described. In some embodiments, end-to-end spiking networks may be constructed for solving more complex non-linearly separable classification problems. For example, three different network architectures are described herein using one or more of the components described above.

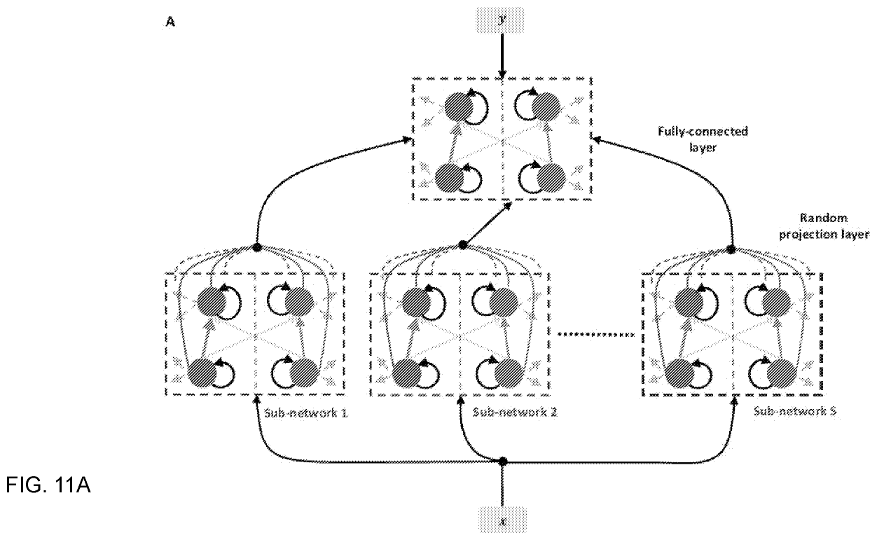

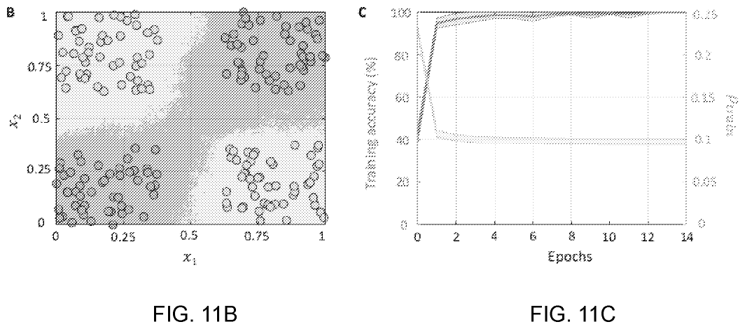

In a first exemplary embodiment, a first network is described using classification based on random projections. The example network architecture, shown in FIG. 11A, includes an unsupervised, random projection-based feature transformation layer followed by a supervised layer at the output. The random projection layer may include S independent sub-networks, each with D differential neuron pairs, where D is the feature dimensionality of the training set. In one example, the transformation matrix for the s-th sub-network may be denoted by Qₛ and its template vector may be denoted by tₛ, s=1, . . . , S. In addition, in a network configuration, each sub-network may be densely connected, but there are no synaptic connections between the sub-networks. When the k-th training data point xₖ is provided to the network, then from (49):

$${\sum }_{i = 1}^{D} {Ψ}_{ski}^{+} + {Ψ}_{ski}^{-} = - ( {\sum }_{i = 1}^{D} {v}_{ski}^{+} + {v}_{ski}^{-} ) = {‖ {Q}_{s} {t}_{s} - {x}_{k} ‖}_{1} , \qquad ( 59 )$$

where Ψ+ and Ψ− are the mean values for the spike function of the i-th differential pair in the s-th sub-network, in response to the k-th data point, and ν+ and ν− are the corresponding mean membrane potentials. A centroid for the s-th sub-network as

cₛ=Qₛtₛ. (60)

When a new data point xₖ is presented to the network, the sum of mean membrane potentials of the s-th sub-network essentially computes the L₁ distance (with a negative sign) between its centroid cₛ and the data point. No training is to take place in this layer. The summed membrane potentials encoding the respective L₁ distances for each sub-network may serve as the new set of features for the linear, supervised layer at the top. For a network consisting of S sub-networks, the input to the supervised layer may be an S-dimensional vector.

A random projection-based non-linear classification with the of an XOR dataset is shown in FIG. 11B. This classification may use 50 sub-networks in the random projection layer and a fully-connected architecture in the supervised layer. FIG. 11B shows training data points belonging to the two classes as circles, as well as the classification boundary produced by the GT network after five rounds of training with different initial conditions, as decided by a majority vote. FIG. 11C plots the evolution of the mean and standard deviation of the training accuracy as well as the sparsity metric with each training epoch. In this example, training for this network architecture only takes place in the top layer and the sparsity gain is minimal.

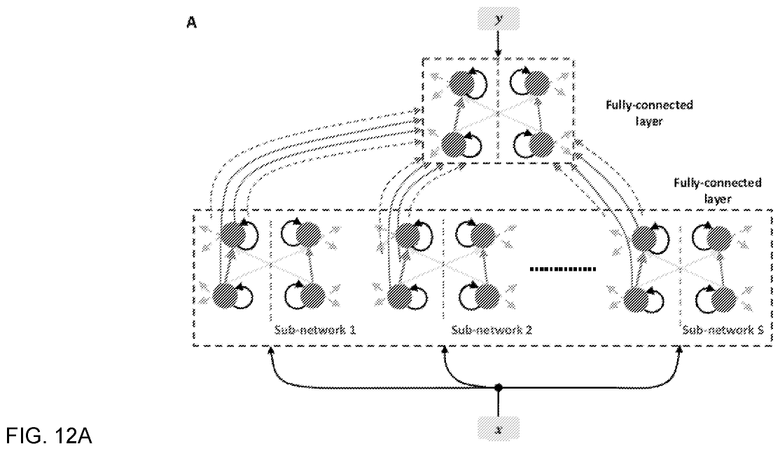

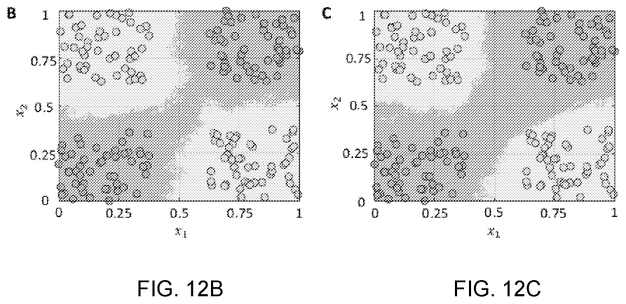

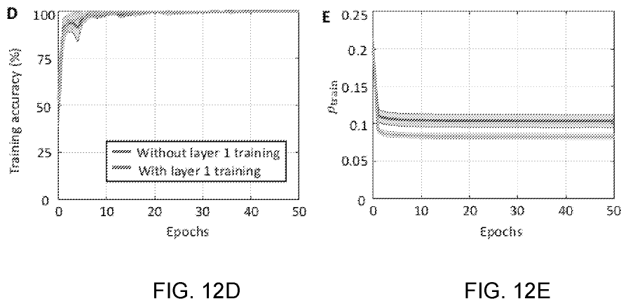

In a second network, classification based on layer-wise training is described. As shown in FIG. 12A, the second network architecture example may include two fully-connected differential networks stacked on top of each other, with connection matrices for the two layers denoted by Q₁ and Q₂, respectively. The first layer may consist of S sub-networks as in the previous architecture, but with connections between them, for example. For the first layer, (35) may be rewritten as follows:

Q₁ν₁=x₁, or

Q₁(ν₁⁺−ν₁⁻)=x₁ (61)

where ν+, ν− are the vectors of mean membrane potentials for the ON and OFF parts of the differential network in layer 1, and x₁=[x, x, . . . , x]^{T} is the augmented input vector, M₁=DS being the total number of differential pairs in layer 1. Since for each neuron pair, only one of ν+ and ν− could be non-zero, the mean membrane potentials for either half of the differential network encodes a non-linear function of the augmented input vector x₁, and may be used as inputs to the next layer for classification. A fully-connected network in the second layer may be used for linear classification. FIG. 12B shows the classification boundary for the XOR dataset with this network architecture.

Further, the first layer may be trained such that it satisfies (61) with much lower overall firing. FIG. 12C shows the classification boundary for a network where synapses in both layers may be adapted simultaneously at first, followed by adaptation only in the last layer. The network may learn a slightly different boundary, but is able to distinguish between the classes as before. As shown in FIG. 12D, 12D plots the evolution of the sparsity metric evaluated on the training dataset for both cases. In the second case, the network may learn to distinguish between the classes with a lower overall network-level spiking activity. Both layers may be trainable for this network and are able to distinguish between the classes with a much lower network-level spiking activity for the dataset.

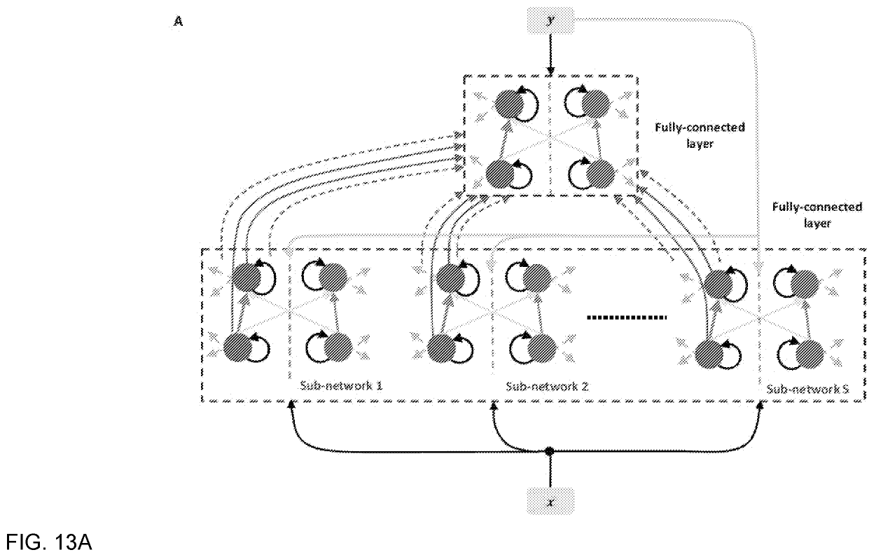

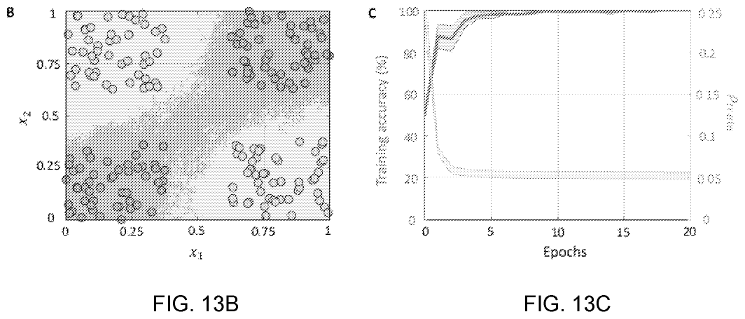

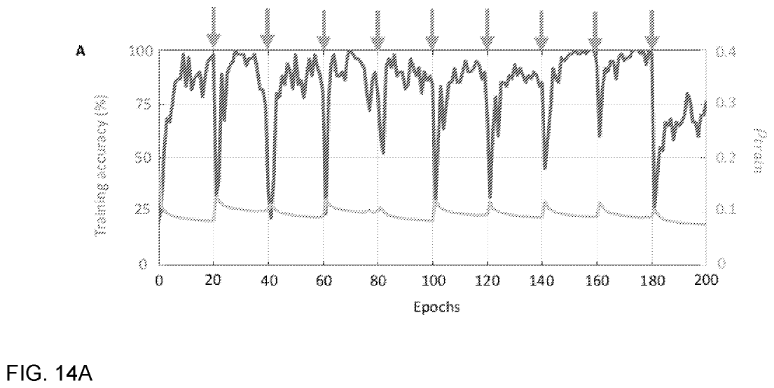

A third example network is now described including target information in layer-wise training of fully-connected layers. In this example, the network may be driven to be sparser by including information about class labels in the layer-wise training of fully-connected layers. The network may then be allowed to exploit any linear relationship between the elements of the feature and label vectors to further drive sparsity in the network. The corresponding network architecture is shown in FIG. 13A. Each sub-network in layer 1 may receive an external input and a corresponding label vector. The top layer may receive a dimensional output vector corresponding to the membrane potentials from the positive part of layer 1 (which in Network 2 encodes a non-linear function of its input) as well as the same label vector. Each layer in the network may be trained with the correct class label. During inference, the network may be presented with a new data point and the network-level spiking activity may be recorded for each possible label vector. The data point may be assigned to the class that produces the lowest firing across all layers of the network.

This example architecture is similar to Direct Random Target Projection which projects the one-hot encoded targets onto the hidden layers for training multi-layer networks. The notable difference, aside from the neuromorphic aspect, is that the disclosed methods use the input and target information in each layer to train the lateral connections within the layer, and not the feed-forward weights from the preceding layer. All connections between the layers may remain fixed throughout the training process. FIG. 13B shows the classification boundary for the XOR dataset with this network architecture. FIG. 13C shows the evolution of the training accuracy and sparsity metric for this problem with the number of training epochs.

Incremental, few-shot learning on a machine olfaction dataset is now described. An example consequence of choosing the sparsest possible solution to the machine learning problem in the proposed framework is that it endows the network with an inherent regularizing effect, allowing it to generalize rapidly from a few examples. Alongside the sparsity-driven energy-efficiency, this enables the network to also be resource-efficient, making it particularly suitable for few-shot learning applications where there is a dearth of labeled data. In one example embodiment, networks 1-3 may be tested to demonstrate few-shot learning with the proposed approach on the publicly available UCSD gas sensor drift dataset. In this example dataset, the dataset includes 13,910 measurements from an array of 16 metal-oxide gas sensors that were exposed to six different odors (e.g., ammonia, acetaldehyde, acetone, ethylene, ethanol, and toluene) at different concentrations. Measurement may be distributed across 10 batches that are sampled over a period, such as three years, posing unique challenges for the dataset including sensor drive and widely varying ranges of odor concentration levels for each batch. Although the original dataset has eight features per chemosensor yielding a 128-dimensional feature vector for each measurement, the present example considers only one feature per chemosensor (the steady-state response level, for example) resulting in a 16-dimensional feature vector, similar to other neuromorphic efforts on the dataset.

In order to mitigate challenges due to sensor drift, the same reset learning approach may be followed for re-training the network from scratch as each new batch becomes available using few-shot learning. The main objectives of the disclosed differ from previous solutions in the following ways: 1) the proposed learning framework is demonstrated on a real-world dataset, where the network learns the optimal parameters for a supervised task by minimizing spiking activity across the network. For all three architectures describe above, the network is able to optimize for both performance and sparsity. Further, a generic network may be used that does not take into account the underlying physics of the problem. 2) End-to-end backpropagation-less spiking networks may implement feature extraction as well as classification within a single framework. Further SNNs that can encode non-linear functions of layer-wise inputs using lateral connections within a layer and present an approach to train these lateral connections.

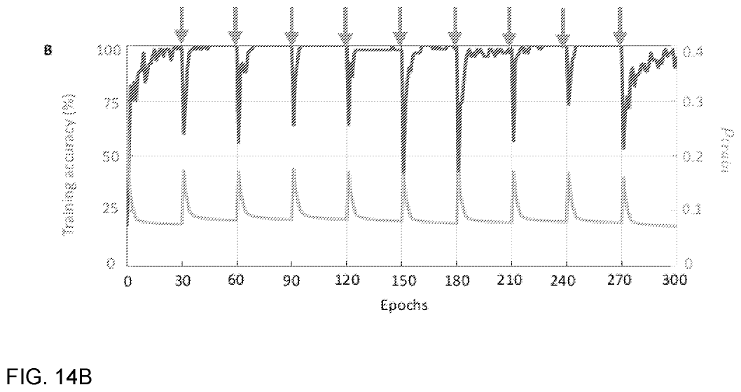

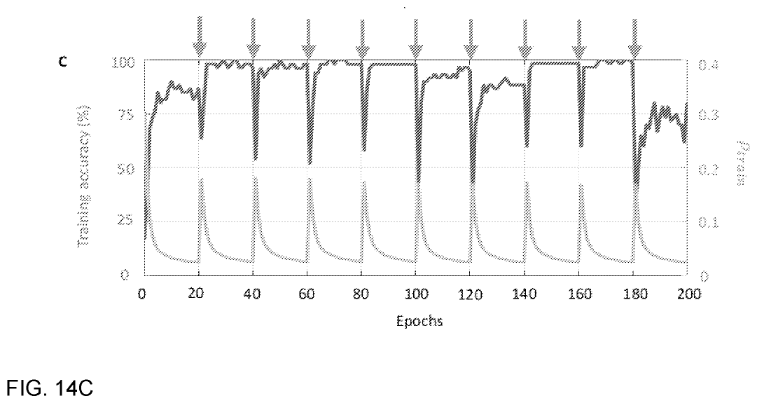

Continuing with the example, for each batch, ten measurements may be selected at random concentration levels for each odor as training data, and 10% of the measurements as validation data. Remaining data points may be used as the test set. For a batch with fewer than ten samples for a particular odor, all samples for the odor within the training set may be included. For Network 1, 50 sub-networks may be used in the random projection layer, which produces a 50-dimensional input vector to the supervised layer. For Networks 2 and 3, the number of sub-networks in layer 1 is 20, generating a 320-dimensional input vector to layer 2 corresponding to the 16-dimensional input vector to layer 1. Moreover, for the first layer in Networks 2 and 3, a connection probability of 0.5 may be used, randomly setting around half of the synaptic connections to zero. FIGS. 14A-14C plot the evolution of training accuracy and sparsity metric (evaluated on the training set) with number of epochs for each phase of re-training for Networks 1-3 respectively. Arrows in each plot mark the onset of a re-training phase (i.e., a new batch). With the arrival of new training data in each batch and for each network, the training error as well as the average spiking activity across the network may increase and subsequently, decline with re-training.

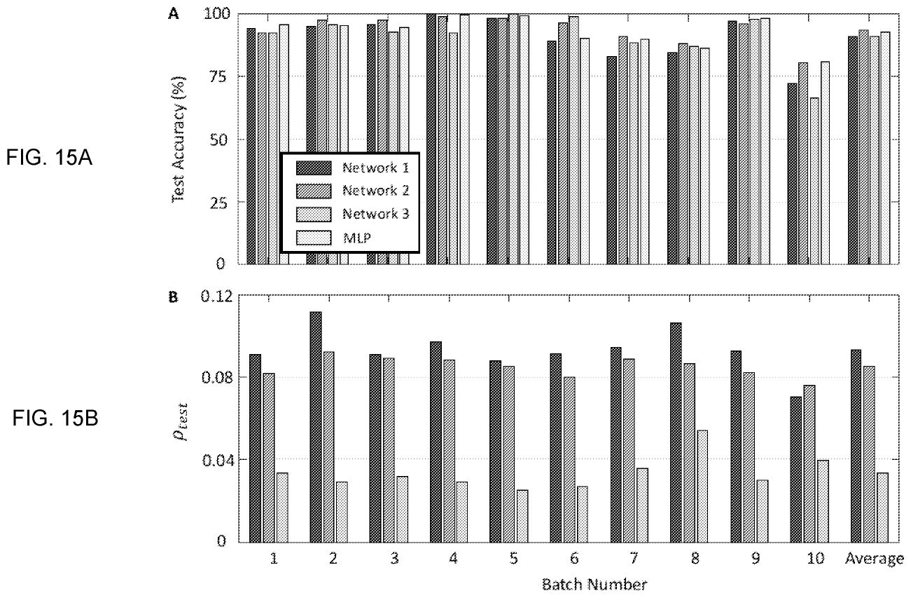

In one example, the performance of the above described network may be compared with standard backpropagation. For example, a multi-layer perceptron (MLP) may be trained with 16 inputs and 100 hidden units for the odor classification problem with a constant learning rate of 0.01 and using the same validation set as described above. The number of hidden neurons as well as learning rate may be selected through hyper-parameter tuning using only the validation data from Batch 1. Table 2 above provides, for example, the number of measurements for each batch, as well as final test accuracies and sparsity metrics (evaluated on the test sets) for each batch for Networks 1-3 with 10-shot learning, as well as the final test accuracies for each batch with the MLP. FIG. 15A shows the batch-wise test accuracies for the three GTNN architectures and the MLP, and FIG. 15B shows the sparsity metrics on test data for the GTNN architectures. The proposed networks may produce classification performance comparable with classic backpropagation-based models, while driving sparsity within the network. The sparsity metrics are highest for Network 1, where synaptic adaptation takes place only in the top layer. Network 2 has the flexibility of training both layers, leading to a decline in the values of the sparsity metric for most batches. In Network 3, synaptic adaptation in both layers coupled with the inclusion of target information drives the sparsity values to less than half of Networks 1-2.

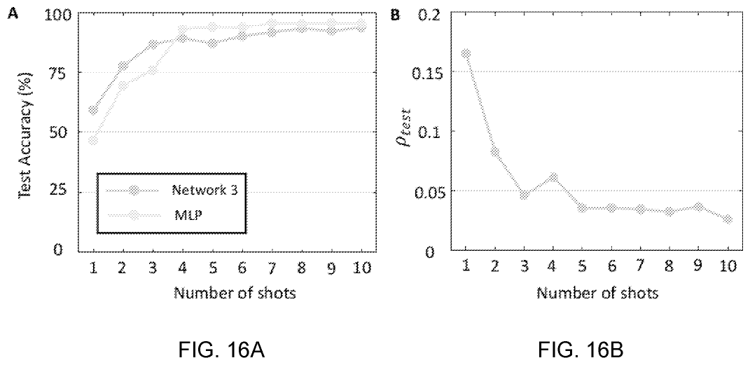

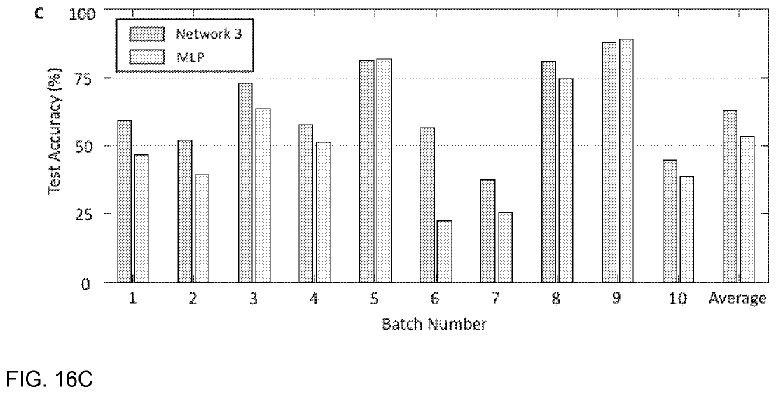

Further, with respect to the above example, when the number of shots (i.e., the number of training data points/class for each phase of re-training is reduced further, the classification performance of GTNN declines more gracefully than standard learning algorithms when no additional regularizing effect or hyper-parameter tuning was done. This is demonstrated in FIG. 16A where test accuracy for one of the batches (Batch 1) with Network 3 as well as MLP may be plotted by varying the number of shots from 1-10. No hyper-parameters may be changed from the previous experiments in order to evaluate recognition performance when no such tuning would be possible under different training scenarios. Although MLP yields similar classification performance as GTNN for a larger number of shots, GTNN has a consistently higher recognition performance for fewer training data points per class. FIG. 16B plots the corresponding test sparsity metrics. FIG. 16C plots the test accuracy of Batches 1-10 with the same two networks for one-shot learning. For most of the batches, GTNN has shown to perform significantly better.

As described herein and above, systems and methods are provided for a learning framework for the Growth Transform Neural Network (GTNN) that is able to learn optimal parameters for a given task while simultaneously minimizing spiking activity across the network. As shown, the same framework may be used in different network configurations and settings to solve a range of unsupervised and supervised machine learning tasks. Further, example results have been provided for benchmark datasets. Additionally, sparsity-driven learning endows GT network with an inherent regularizing effect, enabling it to generalize rapidly from very few training examples per class.

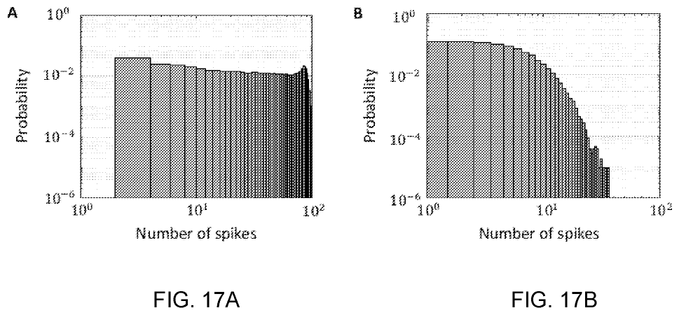

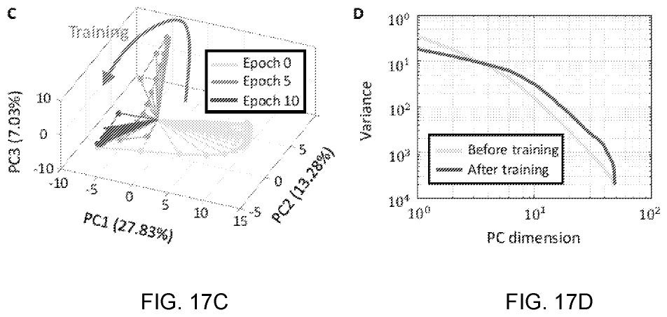

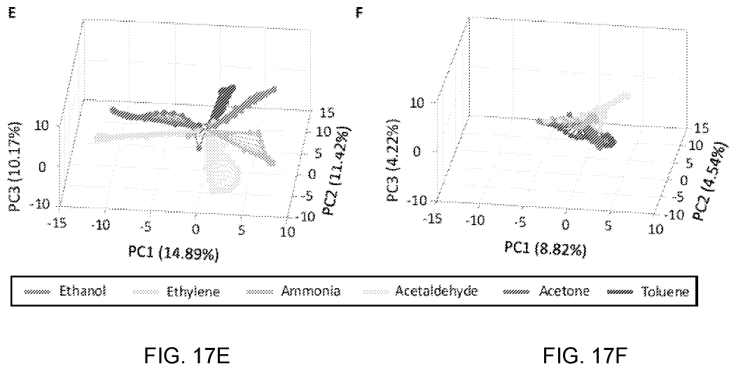

In further embodiments, a deeper analysis of the network and the synaptic dynamics reveals several parallels and analogies with dynamics and statistics observed in biological neural networks. For example, FIG. 17 shows how the population activity evolves in the GT network with synaptic adaptation using the proposed learning framework. FIGS. 17A and 17B plot the probability histograms of spike counts elicited by individual neurons in response to the same set of stimuli before and after training in log-log scale. There may be a distinct shift in the range of spike counts from higher to lower values observed before and training, as expected in sparsity-driven learning.

FIGS. 17C, 17E, and 17F illustrate how network trajectories evolve as training progresses. In one example, stimulus encoding by a population of neurons is often represented in neuroscientific literature by a trajectory in high-dimensional space, where each dimension may be given by the time-binned spiking activity of a single neuron. This time-varying high-dimensional representation may be projected into two or three critical dimensions using dimensionality reduction techniques, such as Principal Component Analysis (PCA) or Linear Discriminant Analysis (LDA) to uncover valuable insights about the unfolding of population activity in response to a stimulus. In FIG. 17C, plotting is shown of the evolution of PCA trajectories of normalized binned spike counts across Network 3 with training corresponding to a training data point belonging to odor 1 (Ethanol). The percentages in the axes labels indicate the percentage of variance explained by the corresponding principal component. For the sake of clarity, only trajectories at three instances of time are shown (e.g., before training, halfway into training, and after training). With synaptic adaptation, the PCA trajectories may be seen to shrink and converge faster to the steady-state, indicating the network-level spiking has reduced. As shown in FIGS. 17E and 17F, plot network trajectories for training data points belonging to six different classes (odors) before and after training respectively on the same subspace. Although the trajectories belonging to different classes are elaborate and clearly distinguishable before training, they are seen to shrink and become indistinguishable after training. Moreover, the net percentage of variance explained by the first three principal components decreases from around 37% to only around 18%. Together these indicate that stimulus representation becomes less compressible with training, relying on fewer spikes across a larger population of neurons to achieve the optimal encoding. FIG. 17D shows the decay in the eigenspectral corresponding to the PCA plots shown sin 17E and 17F. Both the spectra, pre-training and post-training, exhibit a power-law decay, a property that has been observed in evoked population activity in biological neurons. However, as shown in FIG. 17D, the eigenspectrum post-training reveals that the network encodes its activity with a code that is higher-dimensional than pre-training.

Implications for neuromorphic hardware will now be described. A GT neuron and network model, along with the proposed learning framework, has unique implications for designing energy-efficient neuromorphic hardware, some of which are outlined below.

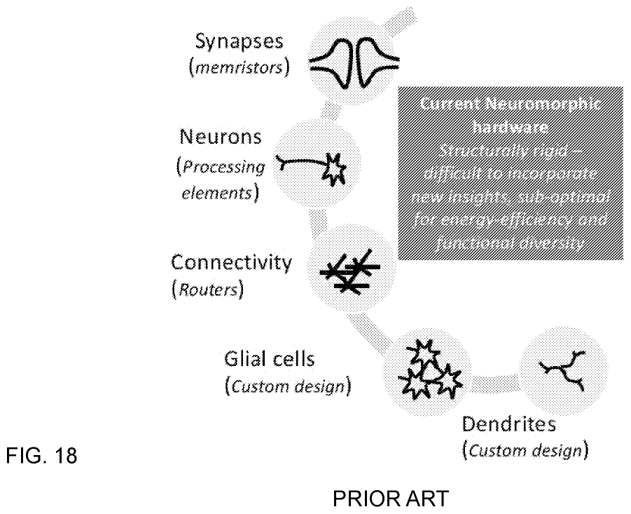

As shown in FIG. 18, prior art neuromorphic hardware, including synapses (memristors), neurons (processing elements), connectivity (routers), glial cells (custom design) and dendrites (custom design) are typically structurally rigid. Because of this, it proves to be difficult to incorporate new insights. Further, neuromorphic hardware structures of the prior art are sub-optimal for energy efficiency and lack functional diversity.

In an example embodiment, in neuromorphic hardware, transmission of spike information between different parts of a network may consume most of the active power. The disclosed embodiments provide a learning paradigm that can drive the network to converge to an optimal solution for a learning task while minimizing firing rates across the network, thereby ensuring performance and energy optimality at the same time.

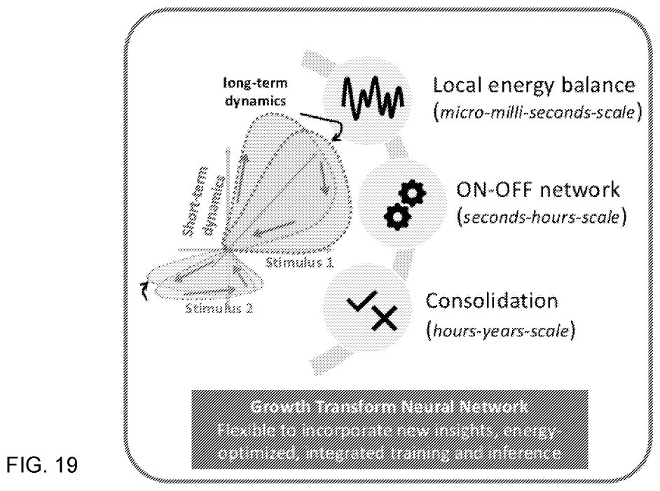

In view of FIG. 19, an example diagram of a growth transform neural network (GTNN) is shown illustrating short-term and long-term dynamics with respect to different types of stimuli described herein. A GTNN provides flexibility to incorporate new insights, is energy-optimized and includes integrated training and inference.

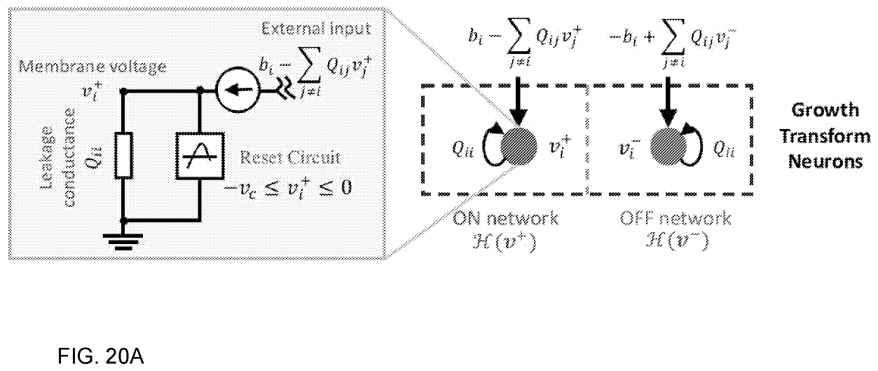

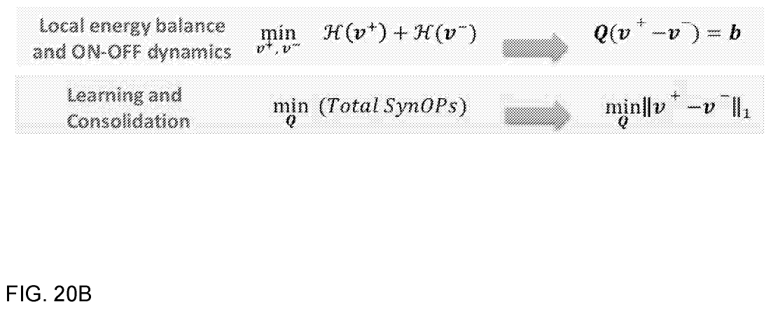

FIG. 20A provides exemplary growth transform (GT) neurons as described herein with respect to an ON network and an OFF network. Each of the GT neurons include a circuit, as diagrammed, which may include, but are not limited to, an external input, a membrane voltage, a leakage conductance, and a reset circuit. FIG. 20B illustrates exemplary local energy balance and ON-OFF dynamics and learning and consolidation.

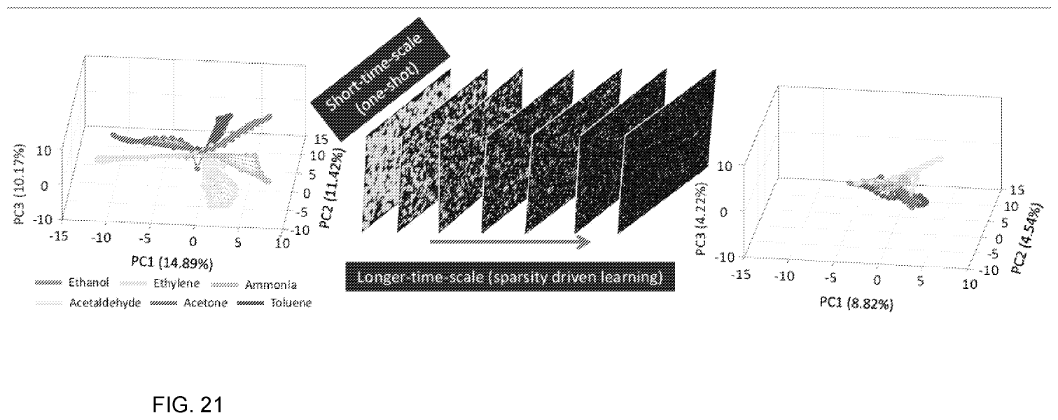

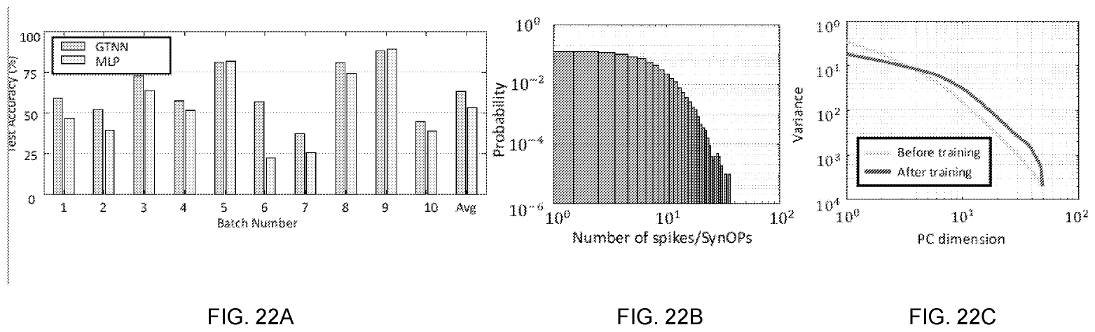

FIG. 21 illustrates plot performance of short and long time scales of a GTNN in accordance with embodiments described herein. In some embodiments, a longer time scale may include sparsity driven learning. FIGS. 22A-22C provide experimental test data results from embodiments described herein with respect to an exemplary GTNN.

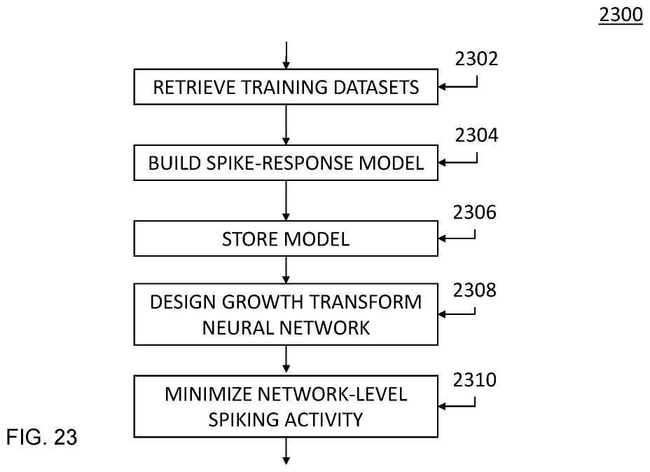

FIG. 23 illustrates an exemplary flow diagram 2300 of the GTNN architecture described. Steps of flow diagram 2300 may be implemented by GT computer device 102 (shown in FIG. 1), for example. In step 2302, at least one or more training datasets are retrieved from a memory device or a database, such as database 106 (shown in FIG. 1). The training datasets retrieved are then used to build 2304 a spike-response model. The spike-response model, in at least one embodiment, may relate one or more aspects of the at least one or more training datasets. The spike-response model is then stored 2306 in a memory device or database, such as database 106. Process 2300 then designs 2308 a growth transform neural network using the spike-response model. In some embodiments, the GT neural network is trained to enforce sparsity constraints on overall network spiking activity. For example, the trained GT neural network may minimize 2310 network-level spiking activity. Additionally, or alternatively, network-level spiking activity may be minimized while producing classification accuracy comparable to standard approaches with respect to the training datasets described herein.

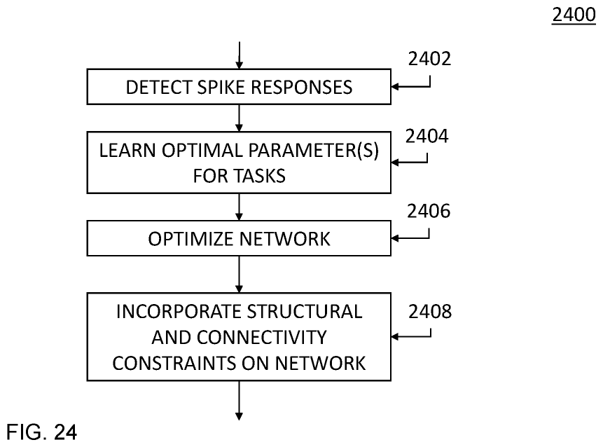

FIG. 24 illustrates an exemplary flow diagram 2400 of the GTNN architecture described. Steps of flow diagram 2400 may be implemented by GT computer device 102 (shown in FIG. 1), for example. Flow 2400 includes detecting 2402 spike responses generated as a result of a constraint violation. In response to the spike responses, the neural network learns 2404 one or more optimal parameters for a task. The optimal parameters may be learned using, for example, neurally relevant local learning rules. The network is then optimized 2406 to encode a solution with a few spikes as possible. Additionally, or alternatively, the network's framework is made flexible enough to incorporate 2408 additional structural and connectivity constraints on the GT neural network.

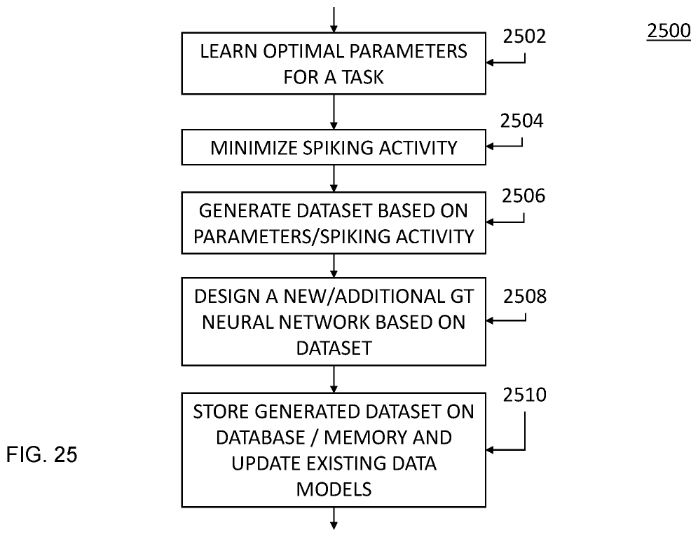

FIG. 25 illustrates an exemplary flow diagram 2500 of the GTNN architecture described. Steps of flow diagram 2500 may be implemented by GT computer device 102 (shown in FIG. 1), for example. In some embodiments, the GTNN architecture may include one or more tinyML devices described herein. A GT neural network of the GTNN architecture may learn 2502 optimal parameters for a task and minimize 2504 spiking activity across the GT neural network. In some embodiments, 2502 and 2504 may be performed simultaneously. Based on optimizing 2502 and 2504, a training data set is generated 2506 based on the learned optimal parameters and spiking activity data on the GT neural network. Another GT neural network may be designed 2508 based on the generated training dataset. Additionally, the new GT neural network may include at least one other tinyML device. In some embodiments, the generated training dataset may be stored on a memory device or database, such as database 106. Even further, the generated training dataset may be used to update existing data models utilized to design and create GT neural networks.

In another example embodiment, unlike most spiking neural networks, which adapt feed-forward weights connecting one layer of the network to the next, the proposed framework presents an algorithm for weight adaptation between the neurons in each layer, while keeping inter-layer connections fixed. This may significantly simplify hardware design as the network size scales up, where neurons in one layer may be implemented locally on a single chip, reducing the need for transmitting weight update information between chips. Moreover, unlike backpropagation, the disclosed algorithm may support simultaneous and independent weight updates for each layer, eradicating reliance on global information. Additionally, this may enable faster training with lass memory access requirements.

The relation with balanced spiking networks will now be described. The balance between excitation and inhibition has been widely proposed to justify the temporally irregular nature of firing in cortical networks frequently observed in experimental records. This balance may ensure that the net synaptic input to a neuron are neither overwhelmingly depolarizing nor hyper-polarizing, dynamically adjusting themselves such that the membrane potentials always lie close to the firing thresholds, primed to response rapidly to changes in the input.

In some embodiments, the differential network architecture described herein is similar in concept and therefore maintains a tight balance between the net excitation and inhibition across each differential pair. Network design as described herein satisfies a linear relationship between the mean membrane potentials and the external inputs. Further, the learning framework described adapts the weights of the differential network such that membrane potentials of both halves of the differential pairs are driven close to their spike thresholds, minimizing the network-level spiking activity. By appropriately designing the network, it is shown that the property could be exploited to simultaneously minimize a training error to solve machine learning tasks.

### Machine Learning & Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as image, mobile device, vehicle telematics, autonomous vehicle, and/or intelligent home telematics data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). In still yet a further embodiment, the system is run on Android® OS (Android is a registered trademark of Google, Inc. of Mountain View, Calif.). In another embodiment, the system is run on Linux® OS (Linux is a registered trademark of Linus Torvalds of Boston, Mass.). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A backpropagation-less learning (BPL) computing device comprising at least one processor in communication with a memory device, the at least one processor configured to:
retrieve, from the memory device, at least one or more training datasets;
build a spike-response model relating one or more aspects of the at least one or more training datasets;
store the spike-response model in the memory device; and
design, using the spike-response model, a Growth Transform (GT) neural network trained to enforce sparsity constraints on overall network spiking activity.

2. The BPL computing device of claim 1, wherein the one or more unique challenges include sensor drift, stimulus concentrations, or both.

3. The BPL computing device of claim 1, wherein the model further includes a learning framework comprising:
spike responses generated as a result of a constraint violation;
one or more optimal parameters for a certain task learned using neurally relevant local learning rules;
network optimization to encode a solution with as few spikes as possible; and
a framework that is flexible enough to incorporate additional structural and connectivity constraints on the GT neural network.

4. The BPL computing device of claim 3, wherein the spike responses are Lagrangian parameters.

5. The BPL computing device of claim 1, wherein, to enforce sparsity, the at least one processor is configured to:
minimize network-level spiking activity while producing classification accuracy comparable to standard approaches on the one or more training datasets.

6. The BPL computing device of claim 1, wherein the GT neural network comprises a neuromorphic tinyML system constrained in one or more of energy, resources and network structure.

7. The BPL computing device of claim 1, wherein at least one of the at least one or more training datasets is a publicly available machine olfaction dataset having one or more unique challenges.

8. The BPL computing device of claim 1, wherein the model is built using machine learning, artificial intelligence, or a combination thereof.

9. The BPL computing device of claim 1, wherein the model is built using supervised learning, unsupervised learning, or both.

10. The BPL computing device of claim 9, wherein minimizing a training error is equivalent to minimizing overall spiking activity across the GT neural network.

11. The BPL computing device of claim 1, wherein the GT neural network includes one or more miniaturized sensors and devices.

12. A neuromorphic tinyML system, comprising:
a growth transform (GT) neural network comprising at least one tinyML device having a memory and a processor, the GT neural network configured to:
simultaneously learn optimal parameters for a task and minimize spiking activity across the GT neural network;
generate a training dataset based on the learned optimal parameters and spiking activity data on the GT neural network;
design another GT neural network comprising at least one other tinyML device based on the training dataset.

13. The neuromorphic tinyML system of claim 12, wherein the GT neural network is further configured to:
store the training dataset on a database communicatively-coupled to the GT neural network.

14. The neuromorphic tinyML system of claim 13, wherein the training dataset is used to develop a training data model for designing new tinyML systems, wherein the training data model is created using the training dataset and one or more additional datasets.

15. The neuromorphic tinyML system of claim 14, wherein the one or more additional datasets is a publicly-available dataset.

16. The neuromorphic tinyML system of claim 15, wherein the publicly-available dataset is a machine olfaction dataset.

17. The neuromorphic tinyML system of claim 16, wherein the training dataset is used to update a training data model for designing new tinyML systems.
